(19) United States
(12) Patent Application Publication
(10) Pub. No.: US 2025/0078248 A1
(43) Pub. Date: Mar. 6, 2025

(54) IN-PROCESS INSPECTION FOR AUTOMATED FIBER PLACEMENT

(71) Applicant: Wichita State University, Wichita, KS (US)

(72) Inventors: Waruna Seneviratne, Wichita, KS (US); Tharaka Nandakumara, Wichita, KS (US); Joshua Goertz, Wichita, KS (US)

(21) Appl. No.: 18/439,757

(22) Filed: Feb. 12, 2024

Related U.S. Application Data
(60) Provisional application No. 63/484,373, filed on Feb. 10, 2023.

(51) Int. Cl. G06T 7/00; G06V 10/25; G06V 10/34; G06V 10/762; G06V 10/774

(52) U.S. Cl. CPC G06T 7/001; G06V 10/25; G06V 10/34; G06V 10/762; G06V 10/774; G06T 2207/20036; G06T 2207/20081; G06T 2207/30164; G06V 2201/06

(57) ABSTRACT

A method of in-process inspection includes acquiring a grayscale image of an automated fiber placement (AFP) workpiece, executing a series of detection algorithms on the grayscale image to identify a plurality of characteristics in the grayscale image indicative of one or more defects in the AFP workpiece, and detecting the one or more defects in the AFP workpiece based on the identified plurality of characteristics.

### CROSS-REFERENCE TO RELATED APPLICATION

This application claims priority to U.S. Provisional Patent Application No. 63/484,373 filed Feb. 10, 2023, which is hereby incorporated by reference in its entirety.

### STATEMENT REGARDING FEDERALLY SPONSORED RESEARCH OR DEVELOPMENT

This invention was made with government support under Grant No. N00014-21-1-2678, awarded by the Office of Naval Research. The government of the United States has certain rights in the invention.

### FIELD

This disclosure generally pertains to inspection systems and, more particularly to an in-process inspection system for use with automated fiber placement (AFP) machines and systems for in-situ inspection of composite parts.

### BACKGROUND

Automated fiber placement (AFP) is a composite manufacturing technique used to fabricate complex advanced air vehicle structures that are lightweight with superior qualities. The AFP process is intricate and complex with various phases of design, process planning, manufacturing, and inspection. The AFP process consists of a gantry/robotic system with an attached fiber placement head. The AFP head enables multiple strips of composite material, or tows, to be laid onto a tool surface. Adhesion between the incoming tows and substrate is ensured by using appropriate process conditions such as heating, compaction, and tensioning systems. A series of tows forms a course, courses are then combined to create a ply, and multiple plies create a laminate.

Although AFP has significantly improved the production rate and quality of laminate structures, the integration of multiple disciplines such as robotics, nondestructive inspection (NDI), and process modeling presents challenges. As the tows from multiple spools are laid down, a wide variety of defects, such as gaps, overlaps, missing tows, twisted tows, puckers or wrinkles, foreign object debris (FOD), and fiber bridging, may be present. Since these defects can have a significant impact on the structural margin of safety, it is important to detect and repair such defects. Quality assurance through inspections and process controls are essential to ensure that material is laid up and processed according to specification without process-induced defects. Currently, AFP processes are interrupted after each layer so that the layup can be manually inspected for defects. This manual inspection process can consume 20-70 percent of the total production time, which diminishes the benefits of automation that would otherwise improve the production rate. In addition, manual inspection processes depend heavily on operator skill and training.

Current industry standard for inspection is primarily visual/manual, which can be inconsistent and subject to human error. Although AFP significantly improves the production rate and quality, a lack of reliable in-process inspection techniques results in intermittent interruptions (20-70% of the production time) for manual inspections. In addition, manual inspection processes are very time intensive, require expert knowledge, and reduce traceability in determining the quality of layup. The time cost of manual inspection is significant, with inspection time growing with the size of each part. This makes producing large scale composites increasingly time and cost prohibitive. Moreover, due to low contrast between the substrate and incoming tows, visual identification of defects has proven to be difficult.

Although thermal imaging, laser profiling, eddy current inspection and other non-destructive testing (NDT) techniques have been employed to ease the difficulty of inspection, improved accuracy and speed of rapid in-process, or in-line, automated inspection is needed.

### SUMMARY

In one aspect, a method of in-process inspection is provided. The method includes acquiring a grayscale image of an automated fiber placement (AFP) workpiece, executing a series of detection algorithms on the grayscale image to identify a plurality of characteristics in the grayscale image indicative of one or more defects in the AFP workpiece, and detecting the one or more defects in the AFP workpiece based on the identified plurality of characteristics.

In another aspect, an in-process inspection system is provided for AFP manufacturing. The in-process inspection system is integrated with an AFP machine configured to deposit composite material tows onto an AFP workpiece. The in-process inspection system includes at least one profilometer is coupled to an AFP head of the AFP machine. The at least one profilometer is configured to collect profile data associated with the AFP workpiece by scanning the composite material tows during operation of the AFP machine. The in-process inspection system includes an automated inspection module comprising a computer having one or more processors and a non-transitory computer readable storage medium. The computer is communicatively coupled to the AFP machine and to the at least one profilometer. The computer is configured to convert the profile data into a grayscale image of the AFP workpiece, identify a plurality of characteristics in the grayscale image indicative of one or more defects in the AFP workpiece, and detect the one or more defects in the AFP workpiece based on the identified characteristics during operation of the AFP machine.

Other aspects will be in part apparent and in part pointed out hereinafter.

### BRIEF DESCRIPTION OF THE DRAWINGS

FIG. 1 is a schematic of an example AFP system;

FIG. 2 is a bottom view of an example inspection tool that may be used in the AFP system shown in FIG. 1;

FIG. 3 is a rear elevation of the inspection tool shown in FIG. 2;

FIG. 4 is an exploded view of the inspection tool shown in FIG. 2;

FIG. 5 shows the inspection tool shown in FIG. 2 during use in an AFP process;

FIG. 6 is a rear elevation of another example inspection tool that may be used in the AFP system shown in FIG. 1;

FIG. 7 is a flow diagram illustrating example grayscale image processing processes for detecting defects in an AFP workpiece under inspection according to an embodiment;

FIG. 8 illustrates an example graphical user interface (GUI) according to an embodiment;

FIG. 9 illustrates an example material selection screen according to an embodiment;

FIG. 10 illustrates a population of the 3D viewport according to an embodiment;

FIG. 11 illustrates an example of an image cropped down to an example region of interest (ROI) according to an embodiment;

FIG. 12 is an example image illustrating a splice image creation side-by-side according to an embodiment;

FIG. 13 is an example image illustrating gap thresholding side-by-side according to an embodiment;

FIG. 14 is an example image illustrating a processed gap result in binary according to an embodiment;

FIG. 15 illustrates an example result of height image machine learning model detection according to an embodiment;

FIG. 16 is an example image illustrating overlap thresholding side-by-side according to an embodiment;

FIG. 17 is an example image illustrating a processed overlap result according to an embodiment;

FIG. 18 illustrates an example of batch image concatenation according to an embodiment;

FIG. 19 is an example user interface illustrating a depth calibration window according to an embodiment;

FIG. 20 is an example user interface illustrating a width calibration window according to an embodiment;

FIG. 21 illustrates an example defect reporting structure according to an embodiment.

FIG. 22 illustrates a hard monument for use in calibrating an in-process AFP manufacturing inspection system (IAMIS) according to an embodiment;

FIG. 23 illustrates the hard monument of FIG. 22 including example sizes of calibration features according to an embodiment;

Corresponding parts are given corresponding reference characters throughout the drawings.

### DETAILED DESCRIPTION

This disclosure generally pertains to inspection systems and, more particularly, to an in-process inspection system for use with automated fiber placement (AFP) machines and systems of the type used to form composite parts by using an automated robotic system including a fiber application head to apply strips of fibers (e.g., composite material tows) to an AFP workpiece in strip-by-strip fashion. Commercially, these types of AFP systems are available from Coriolis Composites SAS, Electroimpact Inc., and Mikrosam, for example. Those skilled in the art will recognize that, in comparison with conventional composite manufacturing systems, AFP systems can automate the manufacture of more complex and intricate parts as they allow for a much greater degree of control over how fibers are laid up in the composite.

Although AFP has significantly improved the production rate and quality of laminate structures, the integration of multiple disciplines such as robotics, nondestructive inspection (NDI), and process modeling presents challenges. As the tows from multiple spools are laid down, a wide variety of defects, such as gaps, overlaps, missing tows, twisted tows, puckers or wrinkles, foreign object debris (FOD), cumulative defects, and fiber bridging, may be present. Currently, AFP processes are interrupted after each layer so that the layup can be manually inspected for defects. The current industry standard for these manual inspections are primarily visual, which provides room for inconsistency due to human error. To increase AFP production rates to match their potential, a system for in-process automated inspection is needed.

Aspects of the present disclosure provide AFP operators and quality inspectors with data in a reliable manner and significantly reduce the need for secondary (e.g., manual) inspection and incidents of human error associated with various levels of operator experience. An In-Process AFP Manufacturing Inspection System (IAMIS) embodying aspects of the present disclosure provides inspection data to the AFP operator as it lays down materials. Various defects may be color coded and labeled in a user-friendly manner for quick response to halt the AFP operation when the repairs are needed. Since the measurements are carried out in-situ within the digital environment, decisions can be made instantaneously, to proceed with AFP or to stop for repair, taking the human errors out of the equation and minimizing the time an operator takes for synthesizing a large amount of data for making the decision.

In one aspect, a method of in-process inspection includes acquiring a grayscale image of an AFP workpiece, executing a series of detection algorithms on the grayscale image to identify characteristics in the grayscale image indicative of one or more defects in the AFP workpiece, and detecting the one or more defects in the AFP workpiece based on the identified characteristics. The series of detection algorithms may include a detection algorithm, a thresholding algorithm, a morphology algorithm, and/or a machine learning algorithm to detect one or more defects. The defects being detected may include a missing tow, a foreign object debris, a twisted tow, a folded tow, a wrinkled tow, a marked splice, an unmarked splice, a backer tape defect, a gap defect, and/or an overlap defect.

In another aspect, an in-process inspection system as described includes an in-process inspection tool mounted on an AFP head and an automated inspection module. The in-process inspection tool may include a profilometer configured to collect profile data by scanning the composite material tows being deposited during operation of the AFP machine. The automated inspection module is capable of running the series of algorithms to flag defects (such as a gap, overlap, splice, twisted or missing tow, foreign object debris (FOD), and cumulative defect) during layup in order to alert trained manual inspectors. Use of such a system decreases overall inspection time by roughly 20-70%, while catching more defects such as those not visible to the naked eye.

In some examples, profilometry utilizes laser projections onto a surface to infer surface features from pattern deviations. This method enables rapid profiling of a surface without considering the surface contrast. However, material type can have a direct effect on the quality of data gathered and therefore the accuracy of defect identification and classification. Aspects of the present disclosure provide improved feature recognition necessary for detecting defects, allowing for more accurate analysis and the identification of a broader range of defects.

For the purpose of the present disclosure, the term “approximately” and similar terms and phrases refers to or represents a condition that is close to, but not exactly, the stated condition that still performs the desired function or achieves the desired result. In one example, the term “approximately” refers to a condition that is within 10% of the stated condition. However, the term “approximately” does not exclude a condition that is exactly the stated condition. Accordingly, the term “approximately equal” may be interpreted to mean equal to or within a desired degree of accuracy.

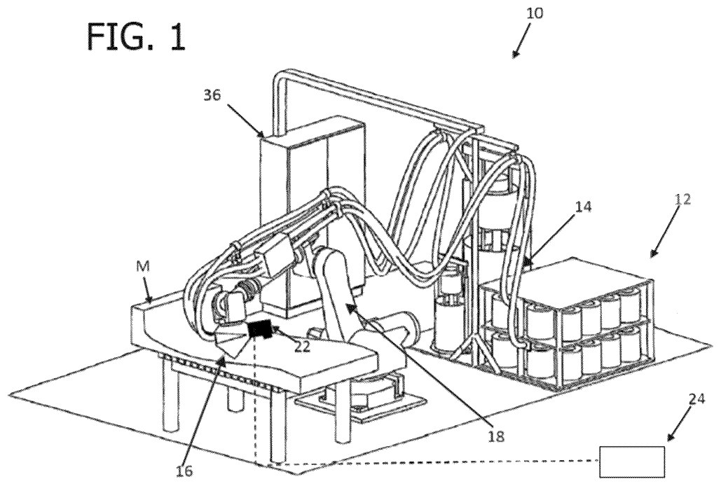

Referring now to FIG. 1, an example automated fiber placement (AFP) system 10 includes a fiber storage facility 12, a fiber conveyor 14, an AFP head 16, and a robot 18. The AFP system 10 is configured to form composite parts with complex geometries and/or complex fiber layup patterns. The fiber storage facility 12 comprises one or more rolls of fiber tows that can be unwound to dispense fiber for use in an AFP process. The fiber conveyor 14 comprises flexible tubes through which fiber tows are conveyed from the fiber storage facility 12 to the AFP head 16 which is configured to guide a strip of resin-impregnated fiber toward a molding M as the robot 18 moves the AFP head 16 along the molding M.

In some examples, the AFP head 16 includes a chassis with a fiber guide operatively mounted on the chassis. A compaction roller may be operatively mounted on the chassis such that the compaction roller is spaced apart from the fiber guide in a trailing direction for compacting the fiber strip onto the molding M. A heating system may be mounted onto the chassis for heating the fiber strip as it is compacted onto the molding M. In some examples, the heating system heats the fiber strip before it is compacted by the compaction roller to soften the resin and promote adhesion of the compacted strip to the underlying molding M.

The underlying molding M defines a surface geometry for a composite part and/or any previously-applied composite material tows. The surface geometry may be complex or of an uncommon shape, as more complex parts are growing in demand within industrial applications. Broadly, the AFP head 16 is configured to place a strip of fibers on the molding M in a predefined fiber orientation. Those skilled in the art will understand that the AFP head 16 may include a number of other components, such as a fiber tensioner, a fiber gatherer, and/or a fiber cutter.

To enable formation of complex and intricate composite parts, the AFP head 16 is mounted onto the robot 18 such that the robot 18 may move the AFP head 16 along the molding M. In some examples, the AFP head 16 may be operatively coupled to the end of the robot 18 having an extensive range of motion along which the AFP head 16 is configured to place the fiber strip onto the molding M. This range of motion will be referred to hereinafter as “the range of motion for fiber placement”. In some examples, the robot 18 is a multi-axis industrial robot 18 configured to move the AFP head 16 through an extensive range of motion. For example, the robot 18 may include a six-axis industrial robot arm, a seven-axis industrial robot arm, a gantry system, or the like. It should be known that other types of robot arms and/or gantry systems may be used without departing from the scope of the current disclosure.

The AFP system 10 includes a control unit 36 configured to execute preprogrammed instructions that define an AFP layup, hereinafter referred to as layup instructions. In some examples, the layup instructions will cause the AFP system 10 to form a plurality of ply layers onto the molding M. For each ply layer, the control unit 36 will direct the AFP system 10 to place a plurality of strips of fiber onto the molding M such that the strips are arranged parallel and side-by-side in a defined fiber orientation.

The control unit 36 broadly comprises one or more control processors and one or more memory modules storing processor-readable control instructions configured to be executed by the control processor(s) for controlling the AFP system 10. The control unit 36 further comprises input/output (I/O) components that enable the control unit 36 to communicate with components of the AFP system 10. For example, the I/O components enable the control unit 36 to send instructions to the robot 18 that cause the robot 18 to move the AFP head 16 along a plurality of predefined fiber placement paths and/or to send instructions to the fiber storage facility 12 and fiber conveyor 14 that cause the storage facility and conveyor to convey fiber tows to the AFP head 16 to place fibers according to the AFP layup instructions. The I/O components may also provide feedback from the AFP process components to the control unit 36.

The AFP system 10 includes an in-process inspection tool 22 mounted on the AFP head 16 and an automated inspection module 24 communicatively coupled to the in-process inspection tool 22. The automated inspection module 24 is configured to receive an in-process inspection signal in order to analyze the surface profile to pre-flag defects such as gaps, overlaps, twisted tows, missing tows, splices, and foreign object debris, which facilitates easing the burden and/or speeding up the job of trained inspectors. The automated inspection module 24 may be used to detect defects which are not visible to a trained inspector's naked eye, such as cumulative gaps and cumulative splices. The automated inspection module 24 comprises a computer configured to execute a series of algorithms, such as a gap defect detection algorithm, an overlap defect detection algorithm, a splice defect detection algorithm, a foreign object debris (FOD) detection algorithm, a twisted tow detection algorithm, a missing tow detection algorithm, and/or a cumulative defect detection algorithm. In some examples, gaps, overlaps, splices, FODs, twisted tows, missing tows, and/or cumulative defects may be detected through the use of various machine learning models.

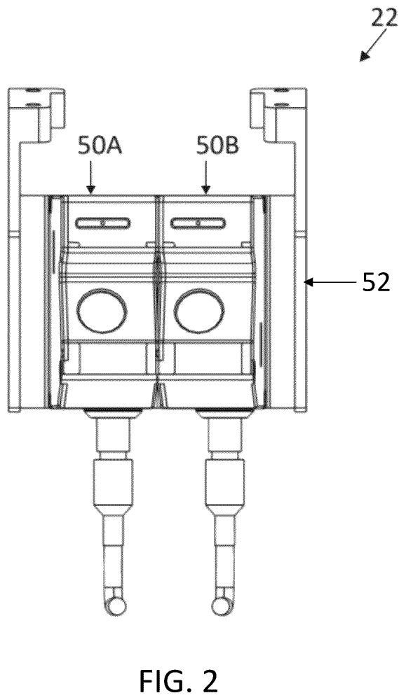

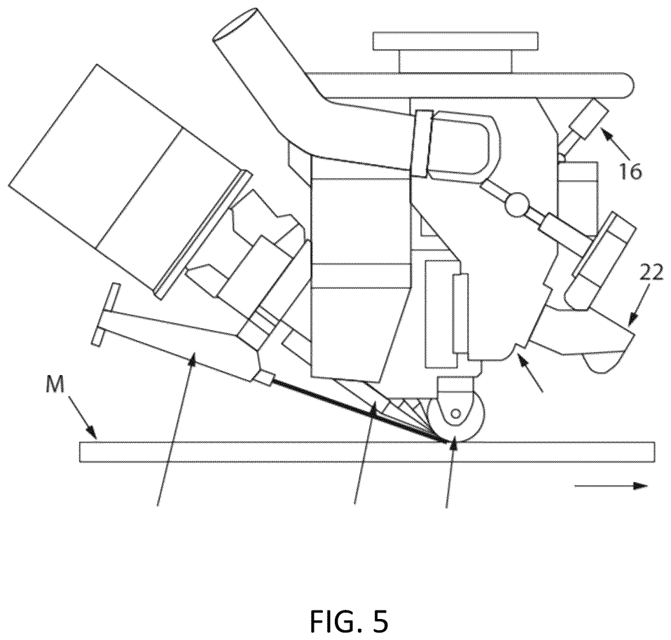

FIGS. 2-4 show an example in-process inspection tool 22 including a plurality of profilometers 50A and 50B (broadly, profilers or a profiling system) and a support bracket 52 configured to mount the profilometers 50A and 50B onto the AFP head 16 (shown in FIG. 1). FIG. 5 shows the inspection tool 22 during use in an AFP process. In some examples, the support bracket 52 includes a bracket mount for mounting the support bracket 52 onto the AFP head 16, and a profiler mount for mounting the profilometers 50A and 50B onto the support bracket 52. Each bracket mount may include a leg portion and a foot portion transverse to (e.g., perpendicular to) the leg portion.

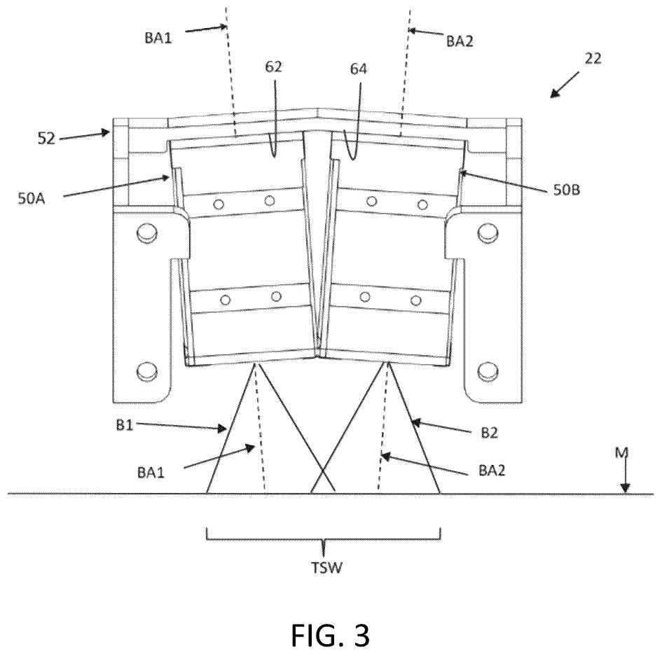

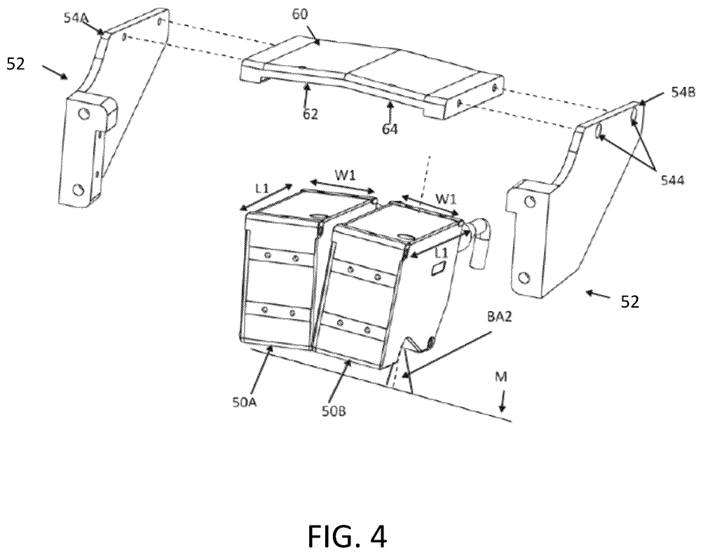

As shown in FIGS. 3 and 4, the support bracket 52 may include a plurality of mounting plates 62 and 64. Each mounting plate 62 and 64 corresponds to a respective profilometer 50A, 50B. As shown in FIG. 4, the upper side of each profilometer 50A, 50B may have a generally rectangular shape or configuration, having a length L1 and a width W1 located along a respective upper side plane. The upper side of each profilometer 50A, 50B may include threaded blind-holes (broadly, “attachment points”) for mounting to a support (e.g., mounting plate 62 or 64).

Each profilometer 50A, 50B may be configured to emit a beam from an upper side and/or an lower side opposite the upper side. An example of a suitable profilometer is a Keyence LJV-7080 profilometer. However, it should be known that other profilometers and profiling systems may have alternative geometries that may be used without departing from the scope of the current disclosure. In an alternative embodiment, the profiling system may include any type of non-destructive testing (NDT) instrument configured to output an indication of the surface profile of the fiber strip as it is compacted onto the molding M. In some examples, the indication of the surface profile is two-dimensional.

The profilometers 50A and 50B allow for immediate integration of the in-process AFP manufacturing inspection system (IAMIS) into existing AFP systems (e.g., AFP system 10). In aerospace applications, Coriolis AFP machines are commonly used with groups of eight quarter-inch tows, which may be deposited with the AFP head 16 onto the AFP workpiece or molding M over a distance. The group of tows deposited over a distance may be referred to as a course. For example, where there are eight quarter-inch tows, the course may have a total course width of 2 inches. If, for example, a Keyence LJV-7080 Profilometer is used to inspect a course having a course width of 2 inches, multiple passes may be used to inspect the entire course width. Using two profilometers 50A and 50B, each having a beam axis BA1 and BA2, and angling them as shown in FIGS. 3 and 4 allows each beam axis BA1 and BA2 to converge, creating a total scanning width (TSW) which may cover the entire course width, allowing the in-process inspection tool 22 to inspect the entire course width in a single pass.

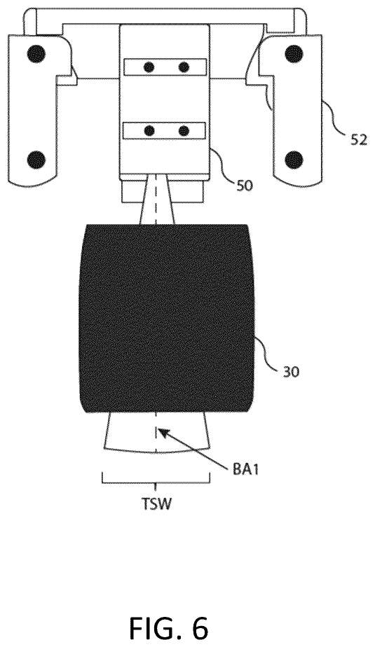

As shown in FIG. 3, the profilometers 50A and 50B may be coupled to support bracket 52 including a first mounting plate 62 and a second mounting plate 64. The first and second mounting plates 62 and 64 join at a vertex which has an angle less than 180 degrees. For example, as shown in FIGS. 3 and 4, the angle may be 172 degrees. Other angles and orientations may be used without departing from the scope of the present disclosure. A single profilometer with the capability of inspecting the total course width may also be used without departing from the scope of this disclosure. For example, courses with a course width less than 2 inches may be inspected with the use of a single profilometer. An illustrated example of this example is shown in FIG. 6. Further, other examples may include a course width of greater than two inches without departing from the scope of the present disclosure.

The support bracket 52 may be sized, shaped, and/or configured to hold the profilometers 50A and 50B such that no portion of the in-process inspection tool 22 interferes with the molding M as the robot 18 moves the AFP head 16 along the entire range of motion for fiber placement. In some examples, the support bracket 52 is configured to mount the profilometers 50A and 50B such that the beam axes BA1 and BA2, respectively, intersect the fiber strip at a location spaced apart from the compaction roller (not shown) in a trailing direction by a spacing distance. For example, the spacing distance may be within an inclusive range of from about 2.7 in to 2.95 in.

A method of using the IAMIS will now be discussed. Overall, the method includes detecting defects first by acquiring a grayscale image of an AFP workpiece, then a series of detection algorithms are executed on the grayscale image to identify a plurality of characteristics in the grayscale image indicative of one or more defects in the AFP workpiece. The one or more defects in the AFP workpiece are detected based on the identified plurality of characteristics.

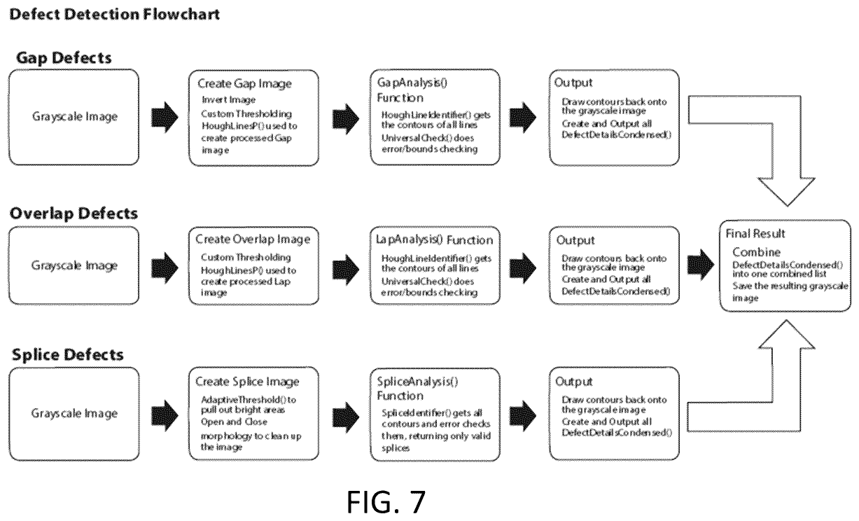

There are different types of algorithms that may be executed by the automated inspection module 24 to determine different types of defects. For example, FIG. 7 shows example algorithms that may be executed to detect a gap defect, an overlap defect, and/or a splice defect in an AFP workpiece under inspection. A gap detection algorithm and/or an overlap detection algorithm may be used to detect gap and overlap defects, respectively. In some examples, the gap detection algorithm and/or overlap detection algorithm may be a thresholding algorithm and/or a morphology algorithm. A height machine learning model may be executed to detect marked and/or unmarked splices, missing tows, twisted tows, wrinkled tows, and folded tows. In some examples, the height machine learning model may be used to detect a bounding box of each possible defect type. A luminance machine learning model may be executed to detect marked splices and/or backer tape defects.

In some examples, a batch image of the AFP workpiece may be created by capturing a plurality of profiles with the profilometer and combining the profile data into a grayscale image. The series of algorithms may be conducted for each batch image, and the results may be recorded on a batch-level list of defects, or a “single batch result”. Each batch result may be sent to a main defect list, which lists defects for all batches at a tape-level. Defects may be reported in a defect reporting system that show the location of the defect on the workpiece, the type of defect, and/or the identification of cumulative defects in the AFP workpiece.

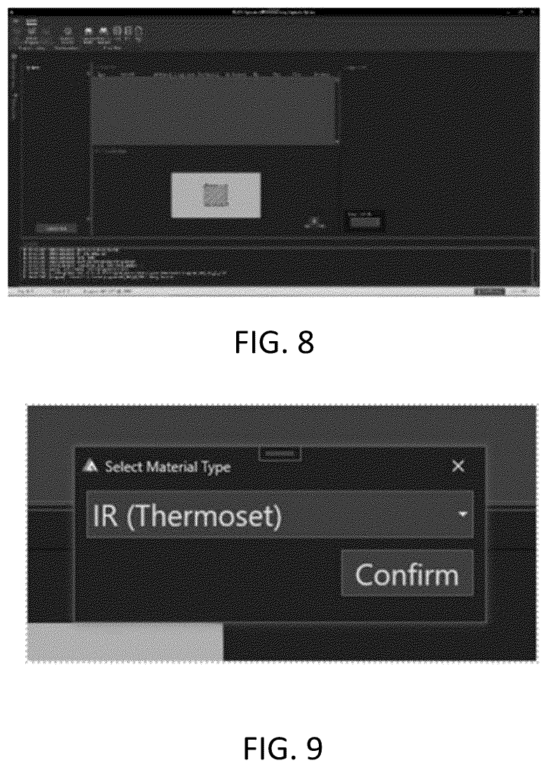

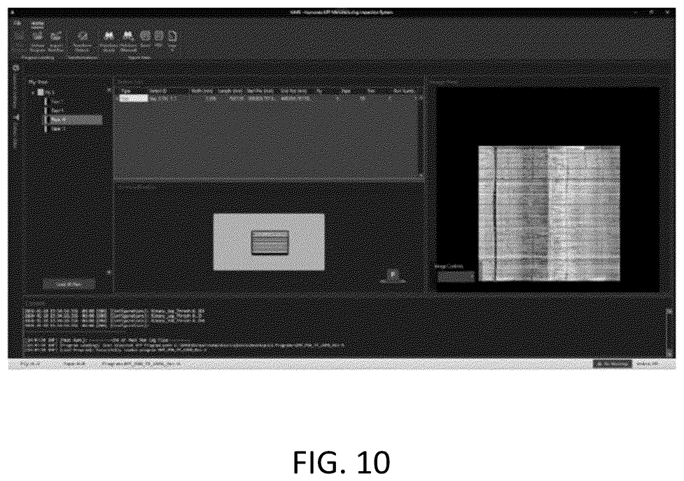

The method begins with launching the IAMIS software on the computer. FIG. 8 illustrates an example graphical user interface (GUI) after the initial software is loaded. In some examples, in order to begin data collection, a CATFiber program is loaded for IAMIS to read. The CATFiber program provides information to the IAMIS system such as a number of plies and tapes, a number and location of fiber added and cuts that were made, as well as toolpath location information. Loading this program prompts the IAMIS system to ask the user which layup configuration will be used. FIG. 9 shows an example material selection screen which indicates a layup configuration of “IR (Thermoset)”. When the IR (Thermoset) layup configuration is selected as shown in FIG. 9, the profilometer is configured to be positioned approximately 68.9 millimeters behind the compaction roller. Alternatively, the layup configuration may be one of a Laser Thermoplastic and a LaserDryFiber. If the Laser Thermoplastic or LaserDryFiber configuration is selected, the profilometer is configured to be positioned approximately 67.56 millimeters behind the compaction roller. It should be known that these measurements are examples, and other layup configurations with alternative parameters and measurements may be used without departing from the scope of the present disclosure. Once a program has been loaded, the IAMIS system populates a 3D viewport which features a first ply's tape boundaries, as shown in FIG. 9.

The AFP system 10 may have a robot 18 to move the AFP head 16 based on instructions including robot position data. The instructions may include, for example, robot position and/or movement parameters for each axis of movement. In some examples, the robot 18 is programmed to move the AFP head 16 so as to deposit tows onto a surface of the tool and build up subsequent layers/plies onto an AFP workpiece. The profilometer coupled to the AFP head 16 collects profile data during the operation of the AFP system 10 while the AFP system 10 is depositing material onto the AFP workpiece. In some examples, the AFP system 10 is a Coriolis machine with a Kuka robot having a RobotSensorInterface (RSI) that provides the position data of the robot 18 along with a timestamp at a particular interval. The profile data and the RSI position data may be collected simultaneously. However, it should be known that other types of robots and movement systems may be used without departing from the scope of the present disclosure.

After the profiles have been captured and/or the profile data has been collected within a certain timeframe, the profile data and/or RSI position data undergo sorting and processing. The number of profiles that have been captured may vary, and the number of profiles captured over a timeframe may be a function of the speed of the AFP head 16. The number of captured profiles are combined into a “batch”. A batch may include any number of profiles without departing from the present disclosure.

In order to sort the profile data and RSI position data, the IAMIS matches the data types together according to the time stamp of each detection. In some examples, profile data is captured at 1000 kHz, while RSI position data is captured every 5 ms. Due to the difference in data collection timing, there may be more profile data points than RSI position data points. To compensate for this, IAMIS may match each collected RSI position data point to its corresponding profile data point, leaving one or more holes for the profile data that have no corresponding RSI position data. IAMIS then fills these holes by interpolating between missing blocks of RSI position data points and matching these interpolations to the profile data points that have no corresponding RSI position data linked yet, resulting in a complete list of profile data points and their corresponding RSI position data points. Depending on the type of robot used for AFP layup, other methods of collecting robot position and time stamps may be used. It should be known that other types of robot position data may be matched to profile data without departing from the scope of the current disclosure, and the above description should be interpreted as an example. In other embodiments, robot position data is not needed to move forward as disclosed in the present disclosure.

Depending on the surface geometry of that which is being scanned, the profiles may have certain levels of distortion. In some examples, the IAMIS system detrends each profile to normalize the profiles in an inclusive range between 0 and 1 using a three-degree polynomial detrend. This detrend process is then performed for every profile within the batch, allowing them to be moved forward to an image analysis step of the method.

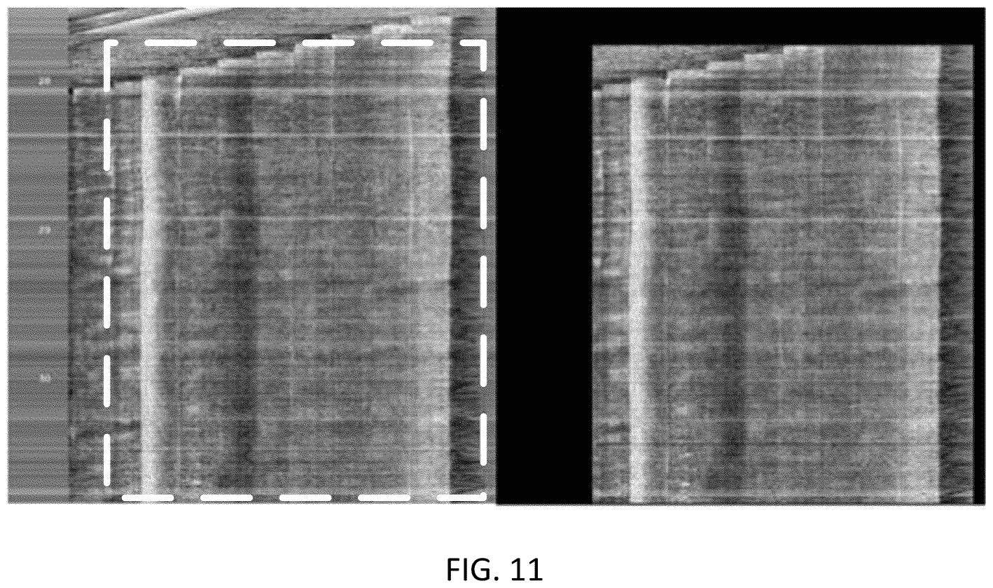

Because the profilometer has a field of view that is greater than the width of an 8-tow course, each batch may be generated using data that overextends past the tape boundary. In order to reduce the likelihood of duplicate defects and false positives created from inadvertently scanning sections of previous plies, the IAMIS extracts relevant information by calculating a region of interest (ROI) for each batch. In some examples, the region of interest is calculated for non-complex flat panels using AFP programmed start and end positions for each tow in the tape, along with user calibrated horizontal tow locations. Then, robot positions are matched with y-indexes in a given batch image, allowing a pixel mask to be created within batch image bounds, replacing x and y indexes with image pixel coordinates. In other examples with more-complex parts, an IAMIS pre-processor is used to predetermine the start, end, left, and right positions for each profilometer line within a given batch. Then the same mask image is generated within the bounds of the batch. Once the ROI is determined and the mask is created, a bitwise AND operation is performed to black out regions of the image that fall outside of the ROI bounds. FIG. 11 shows an image cropped down to an example ROI. Additionally, any area outside of the ROI bounds are included in a list of ignored regions, which is used to ensure that no defects can be reported outside of the ROI. Within a user interface, the designated ROI may be identified by a rectangle (shown in dashed lines) on an output image, as shown in FIG. 11.

In some examples, splices, missing tows, twisted tows, wrinkled tows, and/or folded tow defects are detected via a machine learning model trained to run based on height images. Henceforward, the currently described machine learning model may be broadly referred to as the IAMIS height model. In some examples, the IAMIS system employs a supervised regression-based Convolutional Neural Network (CNN) to identify various features in the height image. The IAMIS height model may be trained based on YOLOv5 to detect bounding boxes of possible splices, missing tows, twisted tows, wrinkles, and/or fold defects in a batch image. In order to achieve this, the height image may be converted to a tensor to be sent to the IAMIS height model. The model may then output a list of dense tensors, which are parsed and converted to a list of predictions. These predictions are scored based on their confidence level. In some examples, a defect with less than 70% confidence is removed from the prediction list, as are any duplicate predictions. However, alternative confidence levels may be used without departing from the spirit and scope of the current disclosure. The resulting prediction list contains each predictions' defect type, bounding box, and confidence level.

For each prediction the IAMIS height model identifies, a conversion process is performed to generate a condensed list of defect details. The first step of this process is to set the defect type, bounding box, and confidence level to the prediction's equivalent values directly. Next, information such as the ply, tape, and batch number are included. A unique defect ID is generated for the defect by combining the defect type, the ply number, tape number, batch number, and an incrementing ID number together, which is then attached to the defect. A check is performed to determine whether or not the defect was a previous repair. The width and height of the defect may then be calculated. Width may be determined using a fixed pixels-per-inch value, and height may be determined by comparing the robot position at the start and end y-indexes of the defect.

Once the list of condensed defect details is generated, each defect undergoes size checks to remove false positives that may have been generated from the model. In general, defects detected by the model should be roughly the width of one tow. For example, if one tow is equal to 128 pixels, it may be determined that any defects detected below 64 pixels are a false positive and may be removed from the defect list. Once size checks are complete, the remaining detected defects are added to a batch level list.

Another algorithm that may be executed includes a luminance machine learning model (broadly referred to as the IAMIS luminance model). In some examples, the IAMIS luminance model is executed after the height batch image has been run through the IAMIS height model. The IAMIS luminance model is configured to detect marked splices and backing tape defects. Marked splices have previously been marked with a color contrasting marker so that the mark is a different shade than the tow. Backing tape may be present on some types of tows as a result of the tow slitting process prior to AFP processing, the backing tape temporarily adheres to one side of the tows, preventing the tows from adhering to underlying tows when the tows are wound onto a spool. Backing tape is considered foreign object debris (FOD) and is not acceptable in the AFP workpiece. Other types of FOD may be detected using the IAMIS luminance model and/or the IAMIS height model.

In some examples, IAMIS employs a supervised regression-based CNN (convolutional neural network) to identify various features found in a luminance image. The IAMIS luminance model may be trained based on YOLOv5 to detect the bounding box of possible marked splices and backer tape defects in a batch image. To do this, the luminance image may be converted to a tensor to be sent to the IAMIS luminance model. The model outputs a list of dense tensors, which are parsed and converted to a list of predictions. These predictions are scored based on their confidence level. For example, In some examples, a defect with less than 70% confidence is removed from the prediction list, as are any overlapping or duplicate predictions. However, alternative confidence levels may be used without departing from the spirit and scope of the current disclosure. The resulting prediction list contains each predictions' defect type, bounding box, and confidence level.

For each prediction the IAMIS luminance model identifies, a conversion process is performed to generate a condensed list of defect details. The first step of this process is to set the defect type, bounding box, and confidence level to the prediction's equivalent values directly. Next, information such as the ply, tape, and batch number are included. A unique defect ID is generated for the defect by combining the defect type, the ply number, tape number, batch number, and an incrementing ID number together, which is then attached to the defect. A check is performed to determine whether or not the defect was previously repaired, and finally the width and height of the defect are calculated. Width can be determined using a fixed pixels-per-inch value, and height is determined by comparing the robot positions at the start and end y-indexes of the defect. For example, the width may be 508 pixels per inch, but this number may change without departing from the scope of the present disclosure.

Once the list of condensed defect details is generated, each defect undergoes size checks to remove false positives that may have been generated from the model. In general, defects detected by model should be roughly the width of one tow. For example, if one tow is equal to 128 pixels, it may be determined that any defects detected below 64 pixels are a false positive and may be removed from the defect list. Once size checks are complete, the remaining defects detected are added to a batch level defect list.

Splices may be detected via a splice detection algorithm. Within a batch image, the splice detection algorithm is configured to search for rectangular-shaped bright spots. In some examples, a rectangular-shaped bright spot may be approximately the width of one tow and have a height greater than zero. From a grayscale image, thresholding takes place to single out bright areas in the image. In some examples, the grayscale undergoes a median blur operation followed by a built-in AdaptiveThreshold operation. After the threshold for the splice image is created, a set of Open and Close morphological operations take place to help clean up the image before further processing. Next, several parameters are defined inside a SpliceAnalysis function to help determine what is described as a splice defect. Those skilled in the art are aware that specifications are set within the industry defining acceptable ranges in which splices are acceptable and should not be recorded as defects. Within the splice detection algorithm, this acceptable range may vary. In some examples, in order to detect unacceptable splices, a mmPerPixel parameter is set, establishing the real-world size of pixels in the image. After the real-world size of pixels in the image has been established, a conversion can be made to determine if a splice of n pixels should be considered a defect or not. While a splice should be completely vertical, there can be irregularities in the scan that cause jitters, slants, or distortions in the grayscale image. A minimum rectangular parameter is then set. For example, this parameter may be set at 0.80, which cuts off detections less than 80% rectangular. In order to discern how rectangular a contour is, the following formula (Eq. 1) may be used:

$$Rectness = \frac{Contour Area}{Bounding Rec tan gle Area} \qquad [ Eq . 1 ]$$

Essentially, the more the contour fills its rectangular bounding box, the more rectangular the contour is. A findRectness function returns the “rectness” of a given contour based on the formula above.

Next, a spliceIdentifier function may be called, which finds contours and bounding boxes in the image, regardless of size. The spliceIdentifier function checks each of the above parameters and filters out any contour that fails the angle, size, or rectangle check.

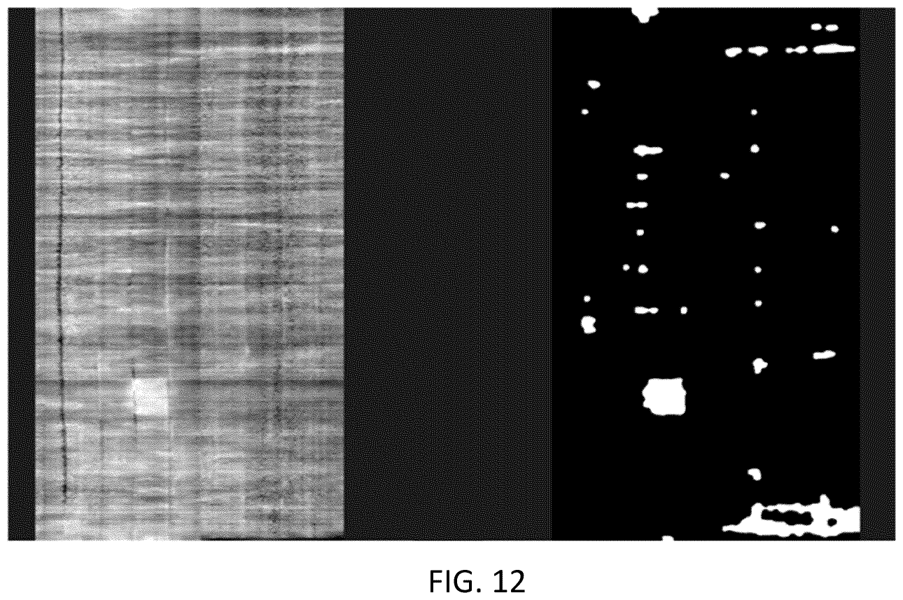

The final step of the splice detection algorithm is to return a list of condensed defects, which store the position, size, and defect ID of each splice defect. In the above example, if the “rectness” of a given contour is greater than or equal to 0.80 (80%), the contour is included with the list of condensed defects, and its position, size, and defect ID will be included on the list. However, alternative levels of “rectness” may be acceptable in alternative examples without departing from the spirit of this disclosure. FIG. 12 shows the final output after detecting splices according to some examples.

IAMIS may incorporate a machine learning model in the image analysis process for detecting splices, missing tows, twisted tows, and/or cumulative defects. Gaps and overlaps may have lower and/or upper thresholds as defined by the manufacturer for width and length which determines if the gap or overlap has to be repaired. The width measurement may also be used to calculate cumulative gaps and/or overlaps. Cumulative defects such as gaps have an upper threshold value over a predetermined area of the AFP workpieces as defined by a manufacturer. Cumulative defects may be measured within the layers of the plies, and in some cases the defects may not be permissible in overlapping areas of the plies. IAMIS measures defects such as gaps and overlaps to confirm if at least one parameter such as width or length is outside of a predetermined, acceptable tolerance range as set by the manufacturer. In this embodiment, the machine learning model constructs a bounding box around the defect, which may be used for detection of each defect.

In some examples, IAMIS uses the YOLOv5 ML model for object detection. The model processes the entire image using a single neural network, then divides it into parts and forecasts bounding boxes and probabilities for each component. This technique enables the model to process the image while implementing very quick real-time object detectors. YOLOv5 architecture is composed of three components in order to make a dense prediction: Backbone, Neck, and Head.

A pre-trained network serves as the backbone and is used to extract rich feature representations for images. This facilitates lowering the image's spatial resolution and/or raising its feature resolution. In some examples, CSP-Darknet53 serves as the foundation of the model. CSP-Darknet53 is a convolutional network Darknet53 using a cross stage partial (CSP) network strategy. In some examples, a BottleNeckCSP module architecture is used for object detection. YOLOv5 uses the CSPNet technique to divide the feature map of the base layer into two sections before merging them. It facilitates speeding up inference to allow for real-time object identification models.

Pyramids of feature data are extracted from the model neck. This enables the model to generalize to objects of various sizes and scales. The model uses an SPPF variant of Spatial Pyramid Pooling (SPP), which provides a fixed-length result after performing aggregation of the data from the inputs. To improve information flow and/or to help in the proper localization of pixels in the task of mask prediction, PANet feature pyramid network modified by applying the CSPNet strategy is deployed.

The final stage operations are carried out on the model head. It renders the finished product by applying anchor boxes to feature maps, including classes, object scores, and bounding boxes. In an example embodiment, it is made up of three convolution layers that forecast where the bounding boxes (x, y, height, and width), scores, and object classes will be. The following Equations 2-5 may be used to compute the target coordinates for the bounding boxes:

$${b}_{x} = ( 2 \cdot σ ( {t}_{x} ) - 0.5 ) + {c}_{x} \qquad [ Eq . 2 ]$$

$${b}_{y} = ( 2 \cdot σ ( {t}_{y} ) - 0.5 ) + {c}_{y} \qquad [ Eq . 3 ]$$

$${b}_{w} = {p}_{w} \cdot {( 2 \cdot σ ( {t}_{w} ) )}^{2} \qquad [ Eq . 4 ]$$

$${b}_{h} = {p}_{h} \cdot {( 2 \cdot σ ( {t}_{h} ) )}^{2} \qquad [ Eq . 5 ]$$

The classes of the detected objects, their bounding boxes, and the object scores are the three outputs produced by the model. The class loss and the object loss are computed using Binary Cross Entropy (BCE). When calculating the location loss, Complete Intersection over Union (CloU) loss is used. The following Equation 6 provides the final loss formula:

$$Loss = {λ}_{1} {L}_{cls} + {λ}_{2} {L}_{obj} + {λ}_{3} {L}_{loc} \qquad [ Eq . 6 ]$$

IAMIS may use a thresholding algorithm to dynamically find darker regions in the batch image. In some examples, the gap detection algorithm begins with a grayscale height image with an ROI already applied. Then the image is inverted, and contrast is increased approximately equal to 1.5 times. Increasing the contrast helps to make potential gaps stand out against any noise that may be in the image. Data is normalized into a single-channel grayscale image where each pixel contains height values normalized between 0 and 255. The closer the value is to 255, or the brighter the pixel, the greater the height at that location. Contrarily, darker pixels indicate lower height values. In some examples, if dark regions have a sudden horizontal dip and rise in image brightness, it indicates that a potential gap exists in that horizontal region. However, when an image is inverted, the opposite is true, as lighter pixels now indicate low height values and darker pixels indicate higher height values.

Next, a line-by-line process is performed on the image to look for neighboring sharp rises and falls in pixel brightness. For each pixel within the ROI, the gap detection algorithm is configured to find current pixel brightness, as well as that of an arbitrary number of pixels to the left and right. The arbitrary number is determined by the IAMIS configuration as previously selected and is subject to change. Once the gap detection algorithm has left, middle, and right pixel brightness values, the difference is found between the current middle pixel and both the left and right pixels. If the difference for each of the left and right pixels are greater than a certain value (also determined by the configuration), then the current middle pixel location is added to a binary gap mask image. In some examples, this process is repeated twice, the first time to find smaller gaps, and the second to find larger and wider gaps. The results are then drawn onto the same binary gap mask image.

Once the binary gap mask image has been created, various operations occur to clean and remove noise from the image. First, if any ignored regions from the ROI exist, black rectangles are drawn onto the mask image to eliminate any white pixels that may exist within those areas. This ensures that no defects will be reported outside of the desired ROI. Next, an open morphology is performed to eliminate noise and other small white regions. In an example, the small white regions being eliminated are less than 3 pixels in size. Following this, OpenCV's HoughLinesP algorithm is used to extract a list of probabilistically generated lines. Each line is then checked to ensure they have angles in an inclusive range approximately between 75° and 105°. It should be noted that other angles may be used without departing from the scope of the present disclosure, and the angles provided are referenced as an example. Checking angles within this range, for example, eliminates any lines that are not roughly vertical.

When all lines have been checked and filtered, the vertical lines are then drawn onto a new blank mask image (a “processed gap mask image”) of the same width and height as the original binary gap mask image. Displaying the lines onto the processed gap mask image facilitates reducing noise in the mask, as well as any non-linear bright spots. Next, black rectangles are added at the horizontal edges of the ROI to remove any false positives that may generate outside of the desired region. The size and shape of these rectangles are controlled according to the chosen configuration and may change according to user preference. Alternative sizes and shapes may be used to eliminate false positives without departing from the scope of the present disclosure.

Up to this point, the processed gap mask image is nearly completely free of noise and it may be determined that any white regions remaining are real gaps. Finally, a close morphology is used to fill in and clean up the edges of the remaining lines, which results in a cleaner defect contour. After the edges are cleaned, OpenCV's FindContours algorithm is used to generate a list of contours around each of the connected white regions in the processed mask image. In some examples, rotated bounding boxes are also calculated around each of the defect contours which will be used to determine values such as pixel width and pixel height of the defect. Defects under a certain width and height are filtered out from being reported. In some examples, a defect approximately below 20 thousandths of an inch is not reported. However, the precise defect size which is intended to be filtered out is subject to change upon user request. Any size may be used for filtering without departing from the scope of the present disclosure.

When the reported contours and their respective bounding boxes are obtained, a condensed list is created which contains the defect's starting position, ending position, an ID number, the layup orientation, the actual defect width, and the length of the defect. In some examples, the list of condensed defects comprises the defect's type, ID, orientation, contour, bounding box, rotated bounding box, width and height both in pixel space and real-world coordinates, its four corner positions, ply, tape, and batch, as well as which tow it was detected on, and its detection confidence. A check is performed to determine if the defect was a repair, and this information is included on the condensed list as well. In some examples, the actual defect width (or real-world width) and length of the defect are calculated values. Width is determined by a fixed pixels-per-inch value. For example, a real-world width may be 508 pixels per inch. This width is variable, however, and may change without departing from the scope of the current disclosure. In some examples, height is determined by comparing the robot positions of start and end y-indexes of the defect. After all defect information is recorded, each entry is added to a batch-level defect list.

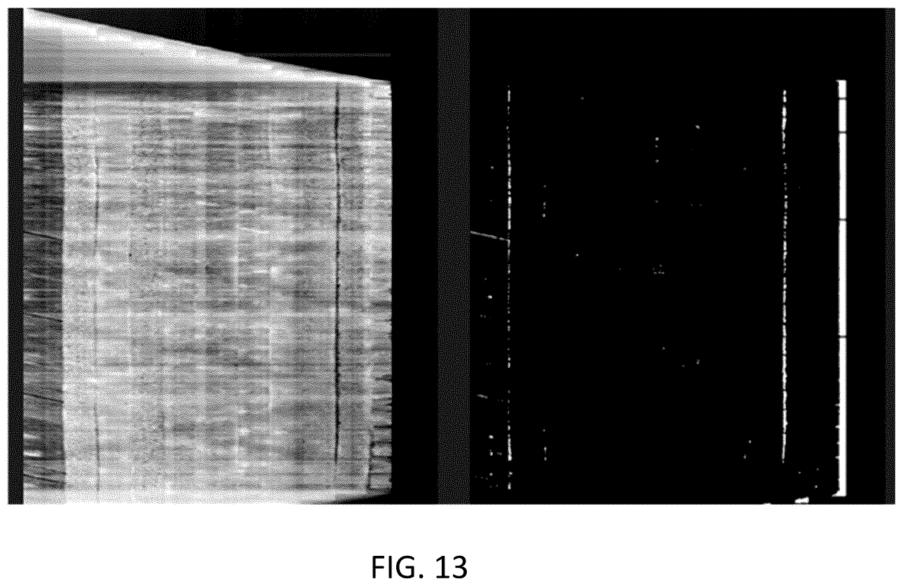

In some examples, the gap detection algorithm begins with a grayscale image. The grayscale image may be cropped down to the desired region of interest (ROI) as described above. A MakeAndRunImage function which is configured to apply a threshold to capture only the dark parts of the image may be applied. In some examples, the grayscale may be inverted, and/or a custom thresholding algorithm may be implemented to extract bright regions in relation to their surroundings. The custom thresholding algorithm is configured to relatively detect differences in brightness throughout the image. Therefore, even if an image is darker throughout, it can still detect the darkest segments that make up gaps due to its relative nature. In some examples, the custom thresholding algorithm may split the image into a plurality of vertical segments. Then, line by line, an average brightness for each segment on each line is calculated. Next, any pixels that are significantly brighter than their respective segment's average are found and added to a new “gap” image, as shown in FIG. 13.

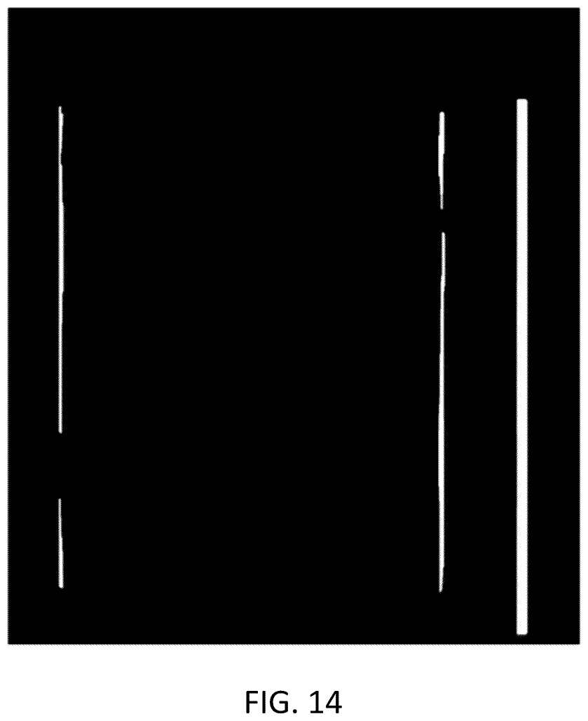

From there, basic morphology and blurring operations are used to remove noise from the gap image. It some embodiments, the custom thresholding algorithm may split the image into a plurality of segments of different orientation or shape while still being within the scope of the current disclosure. OpenCV's HoughLinesP function is applied to the gap image. This pulls out an extensive series of detected lines across the image, including multiple from the same defect. From there, a new blank binary image is created with the exact dimensions as the gap image. Then, each line detected from HoughLinesP is drawn onto this new image, under the condition that the line was within 60-120° as shown in FIG. 13. An example of the processed gap mask image is shown in FIG. 14.

In some examples, the plurality of vertical segments or batch images include a number of pixels in an inclusive range between 100-500 pixels, also referred to as lines. Then, the algorithm is run on sections having heights in an inclusive range from 100 to 1000 lines at one time. In some examples, the segments are analyzed using a moving window having a size of 500 lines. As the window continues to move, an overlapping window of 100-200 pixels may be maintained between two neighboring 500 line windows to stitch the batch images together, which accounts for defects that are located on a border of the previous window or defects that extend beyond the previous window. For example, the in-process inspection system collects data at a rate of 500 lines per second. For another example, inspection can process at a rate between 500-2000 Hz. In some examples, inspection occurs at a rate of 1 kHz, or 1000 cycles per second. It should be known that the number of pixels and section heights, as well as the rate of inspection are all variables that may vary according to speed, rate, or layup configurations of the AFP head 16. Alternative segmentation methods, section heights, and numbers of pixels may be used without departing from the scope of the current disclosure.

A HoughLineIdentifier function is used to add left and right cutoffs, clean up the images with a Close morphology, and then find the contours of the image and their respective bounding boxes. To safeguard from any errors that may occur, a UniversalCheck function is used to prevent two defects from overlapping, ensuring that the bounding boxes are oriented the correct way and removing small false detections. The UniversalCheck function uses various checks, such as angle, position, and intersect functions.

The result of the UniversalCheck is a list of correct contours and their bounding boxes. Each defect's width is the final parameter required which is used to find the actual width of the defect in pixels (hereinafter referred to as the “actual defect width”). There are several options for methods to find the actual defect width.

For example, the defect's width may be found using a method of matching the Y value of contour points. This method includes setting the contour chain approximation to ChainApproxNone. The chain approximation is OpenCV's way of saving memory regarding contours. However, by disabling the approximation, the point for every pixel along the contour can be obtained. As the name suggests, two points are matched with equivalent y values. Once two points have been found, the defect width can be determined by subtracting one point's X value from the other's X value.

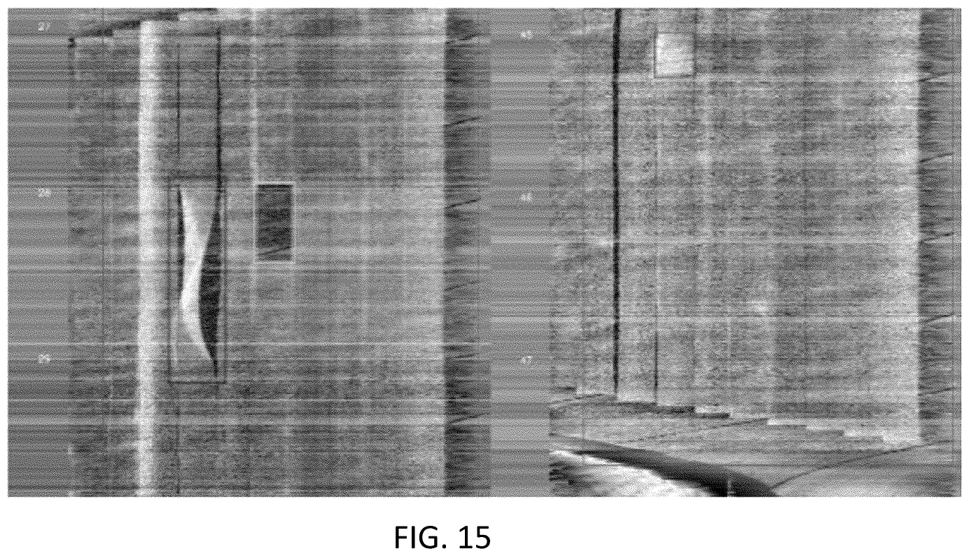

For another example, the defect's width may be found using a PointPolygon Test. This method benefits from the efficiency of not needing to search a large 2D array. In some examples, OpenCV is used, which contains a function called PointPolygonTest which returns whether or not a point lies within a given contour. By creating a “line” of points spaced one pixel across along the width of the bounding box, the total number of points can be used to find the actual contour width. In FIG. 15, the points lying within the contour are drawn in a first color (e.g., green), while the points outside the line are in a second color (e.g., red). Adding up the number of points in the first color results in the pixel width of the contour where then three vertical points of the contour are measured.

In some examples, detecting overlaps may begin with a grayscale image wherein the contrast has been increased by 1.5 times. This allows potential overlaps to stand out against the noise of the image. Then, the line-by-line process is performed to search for neighboring sharp rises and falls in pixel brightness. For each pixel within the ROI, the algorithm finds current pixel brightness and that of the pf the pixels an arbitrary number of elements to the left and right, as is determined by the IAMIS configuration chosen. If the difference for both the left and the right is greater than a certain value (also determined by the configuration), then the current middle pixel location is added to a binary mask image. This process may occur twice, the first time tuned to find smaller overlaps, and the second time tuned to find larger and wider overlaps. The differences in the two passes are limited to the left and right seeking distance and minimum value difference between brightness values (both of which are determined by separate configuration values for wider overlaps). The results are drawn to the same mask image.

Once the binary mask image has been created, various operations are used to clean and remove noise from the image. First, if any ignored regions from the ROI exist, black rectangles are drawn onto the mask image to eliminate any white pixels that may exist within those areas. This ensures that no defects will be reported outside of the desired ROI. Next, an open morphology is performed to eliminate noise and other small white regions. In some examples, the small white regions being eliminated may be less than 3 pixels in size. Following this, OpenCV's HoughLinesP algorithm is used to extract a list of probabilistically generated lines. Each line is then checked to ensure they have angles in an inclusive range between 75° and 105°. It should be noted that other angles may be used without departing from the scope of the present disclosure, and the angles provided are referenced as an example. Checking angles within this range, for example, removes any lines that are not roughly vertical. When all lines have been checked and filtered, the vertical lines are then drawn onto a new blank mask image (a “processed overlap mask image”) of the same width and height as the original binary gap mask image. Displaying the lines onto the processed gap mask image is useful in eliminating any noise remaining in the mask, as well as any non-linear bright spots. Next, black rectangles are added at the horizontal edges of the ROI to eliminate any false positives that may generate outside of the desired region. The size and shape of these rectangles are controlled according to the chosen configuration, and may change according to user preference. Alternative sizes and shapes may be used to eliminate false positives without departing from the scope of the present disclosure.

At this point, the image is nearly completely free from noise, and it may be determined that any remaining white regions are real overlaps. Finally, a close morphology is used to fill in and clean up the edges of the remaining lines, which results in a cleaner defect contour.

For each defect, a list may be created containing the defect starting position, the ending position, an ID number, the layup orientation, the actual defect width, and the length of the defect. Once all gap defect objects have been created, a GapAnalysis function returns a list of the gaps. Alternatively, the condensed list as described in some examples may also be used.

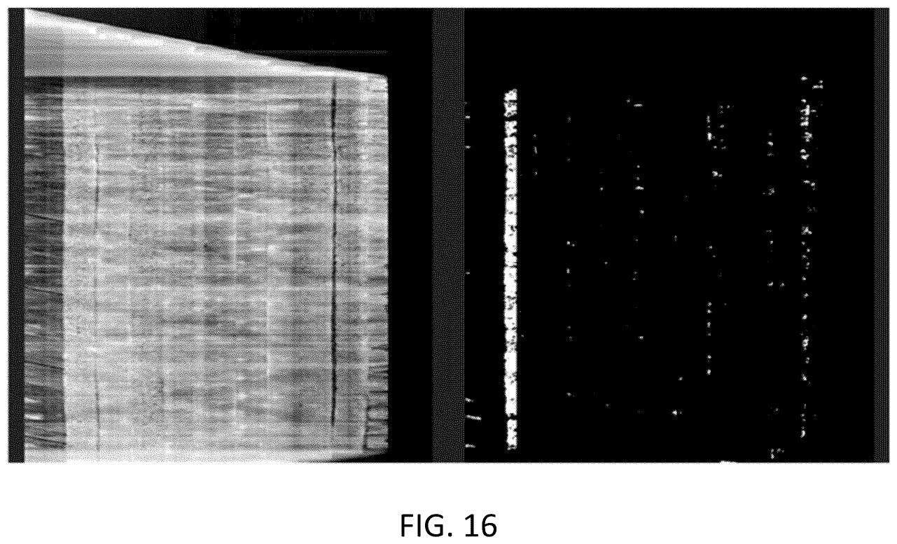

In some examples, the overlap detection algorithm begins with a grayscale image. The custom thresholding algorithm for overlaps may be similar to that which was previously discussed within the gap detection algorithm. Said algorithm splits the image into a plurality of individual segments, finding the average brightness of each segment, and adding any pixels that are significantly above that average into a new “overlap image” as shown in FIG. 16.

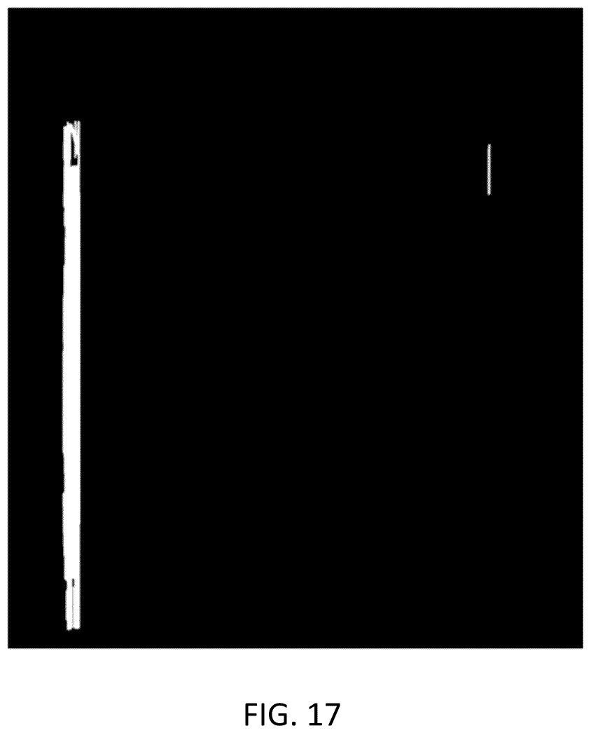

From this point, the overlap image undergoes the same or similar HoughLinesP method as the gap analysis, which is configured to find the lines in the overlap image and add the found lines to a new blank image for further processing. Then, within a LapAnalysis function, a call to HoughLineIdentifier is used to clean up the image further, add any cutoffs, and find the contours around the defects and their bounding boxes. FIG. 16 is an example image illustrating a processed overlap according to an embodiment. An example of the processed overlap mask image is shown in FIG. 17.

In some examples of the overlap detection algorithm, gaps are given preference over overlaps. This means that if a gap exists in a given space in the image, an overlap may not be generated within an arbitrary number of pixels of the detected gap. For example, an arbitrary number of pixels may be 100 pixels, however other numbers may be chosen without departing from the scope of the present disclosure. Setting this threshold reduces the likelihood of false positives, as the overlap detection algorithm may determine the sudden intensity changes created by gaps as an overlap. For example, in FIG. 17, the processed overlap mask image contains white pixels on the left side of the image, even though there is a gap at that location. To solve this, the IAMIS system goes through each previously detected gap defect and draws a series of solid black rectangles in the overlap image corresponding to the bounding box of each detected gap, with an added cushion of the arbitrary number of pixels chosen (for example, 100 pixels), to the left and right.

In some examples, the UniversalCheck function is called, which corrects any issues and removes any contour overlaps. The UniversalCheck function is also configured to ensure that no Overlap is created near a Gap defect. In the case of an overlap appearing very close to a gap, the overlap detection algorithm is configured to remove the overlap if the gap is more significant in size. If the overlap is significantly larger than the gap, the overlap detection algorithm is configured to remove neither, leaving both the gap and overlap alone. This feature enables the overlap detection algorithm to remove small brightness differences that result from appearing next to a large gap.

After the edges are cleaned and processed as described within the gap detection algorithm, OpenCV's FindContours algorithm is used to generate a list of contours around each of the connected white regions in the processed mask image. Rotated bounding boxes are calculated around each of the defect contours which will be used to determine values such as the pixel width and pixel height of the defect. Defects under a certain width and height are filtered out from being reported. In some examples, a defect below 20 thousandths of an inch are not reported, however this number can be changed without departing from the spirit and scope of this disclosure.

When the reported contours and their respective bounding boxes are obtained, a condensed list is created which contains the defect's starting position, ending position, an ID number, the layup orientation, the actual defect width, and the length of the defect. In some embodiments, the list of condensed defects comprises the defect's type, ID, orientation, contour, bounding box, rotated bounding box, width and height both in pixel space and real world coordinates, its four corner positions, ply, tape, and batch, as well as which tow it was detected on, and its detection confidence. A check is performed to determine if the defect was a repair, and this information is included on the condensed list as well. In some examples, the actual defect width (or real-world width) and length of the defect are calculated values. Width is determined by a fixed pixels-per-inch value. For example, real-world width is 508 pixels per inch. This width is variable, however, and may change without departing from the scope of the current disclosure. In some example, height is determined by comparing the robot positions of start and end y-indexes of the defect. After all defect information is recorded, each entry is added to a batch-level defect list.

In some examples, a LapAnalysis function is run which is configured to return a list of defects. Once the defect is detected, based on the orientation in which the layup is done, the difference between the start of the defect and the end of the defect gives the height of said defect.

Foreign Object Debris detection begins in a similar fashion to gap and overlap detection. In some examples, the custom thresholding algorithm for detecting foreign object debris is similar to that which was previously discussed within the gap detection algorithm. Said algorithm splits the image into a plurality of individual segments, finding the average brightness of each segment, then adding any pixels that are significantly above said average into a new “FOD” image.

Throughout the layup process, some defects are allowed to remain unrepaired as long as they are within a predetermined tolerance. Some tolerances have simple parameters, such as not exceeding a set length or width. However, others consider cumulative defects within a given area. In an embodiment, the three types of defects included in cumulative defect classifications are splices, gaps, and overlaps. A cumulative defect algorithm will now be described.

In order to allow a splice to remain in a part, overlapping splices and direct distances are considered. For example, if the number of splices that are overlapping perpendicular to the surface of the part exceed a predetermined amount, then the defect must be repaired. In another example, if there is a splice which has a distance to another splice that is less than an allowable amount, then at least one of the splices will need to be repaired.

To identify splice defects that are outside of the allowable specifications, parameters are specified in IAMIS configuration for each criterion considered (number of allowable overlapping splices and minimum distance between splices). As each ply is completed and defect detection is taking place, a check for each of the specified criterion takes place as well.

In some examples, in order to check for overlapping splices, a normal vector for each corner on a splice region is calculated. All of the splices within a part are then compared to see if the region formed by their four corners intersects with the normal vector. In some examples, this embodiment is used for complex parts with complex contours. Alternatively, when this embodiment is used with flat panels, the normal vector may be the same as a z-axis vector, so all that needs to be checked is if the XY point is within the XY region.

To determine the minimum distance between splices, a shortest distance between splices is calculated. The shortest distance is found by finding two lines, one from each respective splice, that are closest to each other. From there, the distance between each start and end point on the two lines is calculated. This distance is the closest distance between the two splices, and is compared against the minimum allowable distance. For example, if the shortest distance is less than the minimum allowable distance, at least one of the detected splices will need to be repaired.

Cumulative defect criteria for gaps and overlaps are the same, and thus may be calculated in the exact same way. For each, there is a maximum cumulative width which is allowed over a specified distance. This distance is along a line that is perpendicular to a direction which the fiber runs. To calculate the cumulative width, a region having a height equal to the gap or overlap length, and a width equal to the distance perpendicular to the fiber direction is first identified. Any defect of a matching type which is either partially or fully contained within that region is found. Starting at a bottom edge of the region, all found defects that intersect with the edge are separated and the cumulative width is found. If this width exceeds the maximum allowable cumulation, each of the defects found within the region are flagged. The cumulative defect algorithm will then move the region up and parallel to the bottom edge in order to find the next instance in which a new defect intersects with the edge, or a defect has been removed from the defect list. When this occurs, the cumulative width is once again calculated. This continues for an entire region before repeating the process for the next type of defect.

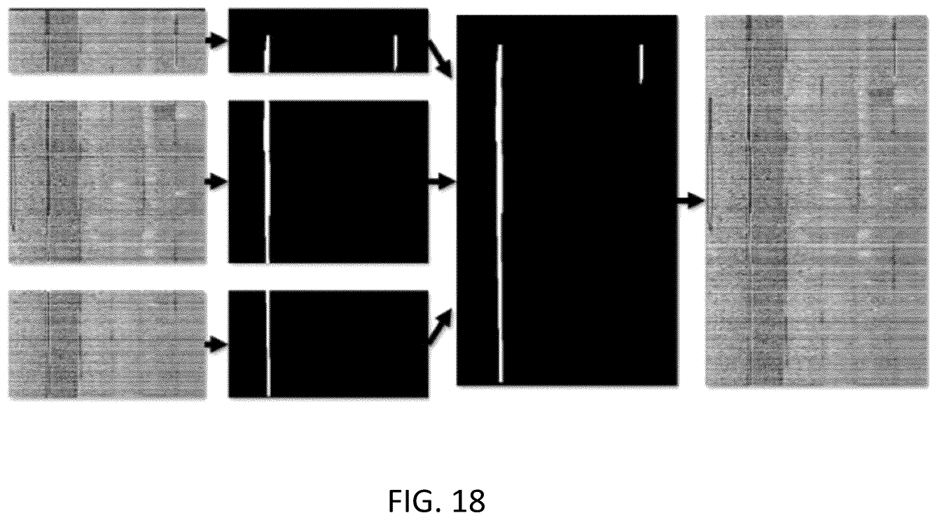

Until this point, each algorithm, operation, or model has returned a list of just one type of defect, or a batch level list of defects. However, this is not an ideal presentation to an end-user. In some examples, one defect may span across multiple batches in length. When this happens, segments of the defect are analyzed in each individual batch, leading to multiple detections for the same defect. To solve this the final step is to concatenate each of these defect types into a main defect list for all batches, which can then be displayed in the IAMIS software to the end-user. This is done using a grouping algorithm once all of the batch level analysis is completed. The batch image concatenation process is illustrated in FIG. 18.

The first step the grouping algorithm is configured to take is for a given defect type, all other instances of the specified defect type are removed from a “tape-wide” level defect list. This ensures that no duplicate defects are shown to the user when a filtering parameter is changed for that defect. The next step is to create a blank tape-wide mask image for that defect type. To do this, each batch has a mask segment generated, whose height matches that of the batch. All contained batch-level defects whose batch numbers match the current segment and whose filter parameters match current specifications have their contours drawn to the mask segment, wherein each mask segment is appended to the tape-level mask image. When all batches have been processed and all mask segments have been appended to the overall mask image, OpenCV's FindContours algorithm is used to find a new list of defect contours. These contours represent tape-level defects and get converted to their own list of condensed defect details. This conversion is very similar to generating batch-level defect lists, with a couple key differences. First, because these defects are not within a single batch, the batch number within the defect ID is set to −1. Further, calculating real-world height of the defect on a tape level comprises concatenating robot positional data as tied to the y-index within each batch. This way, a tape-wide list of robot positions is available to match with the tape-wide mask image for each defect type, meaning real-world defect length calculation can be performed over multiple batches.

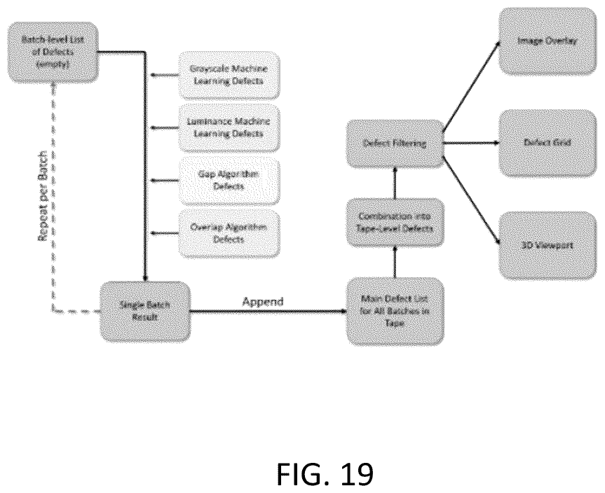

The last step of this process is to report each defect which makes up part of the defect reporting system as shown in FIG. 19. In an embodiment, the IAMIS Graphical User Interface as pictured in FIGS. 8 and 10 has multiple defect reporting components: a defect list, or defect grid, a 3D viewport, and an image view. The defect grid includes all of the previously collected and described information of each detected defect and allows users to track whether a defect is within specification. The 3D viewport is a 3D environment that contains the tool being laid up on, along with the ply boundaries of the layup. When defects are detected, they are colored based on the defect type, and placed in the 3D viewport at their detected location. This assists operators in not only finding defects, but also their location in relation to the part. The image view is configured to display the most recent image generated by IAMIS, along with any detected defects marked with colored boundary lines based on the defect type. The IAMIS GUI further comprises a tree view navigation component which stores all layup information in an easy-to-use format. Any time a new play is started, it is automatically added to the tree view, along with all of the tapes scanned within that ply. When a user clicks on any tree view element, the rest of the GUI is updated with only the information regarding that element. If a user clicks on a ply, then the defect list and 3D viewport display all information within that ply. If a user clicks on a tape, the defect list and 3D viewport are again updated, and image view also displays a stitched image of all of the batch images generated in the tape. When a repair occurs during a layup, the repaired tape is resultingly marked with a repaired icon. When a tape is repaired, the user has the option to view both the original layup image, and the repaired layup image using a context menu.

The IAMIS GUI further comprises a second navigation component, the navigation bar, which allows users to execute a variety of different commands and output defects in different environments. The user has the option to load a program for in-process inspection, or to load a past run back into the software. The user can also export the detected defects to the visualization system, the visualization system to be described in greater detail later, an excel spreadsheet, or a PDF.

In the image view, or the area of the GUI in which the selected image is populated, the defects are displayed by generating an overlay image of all defects and displaying it on top of the height or luminance images. Information is displayed regarding each of the tape-level defects, and a 3D viewport displays lines to indicate each defect's bounds in 3D.

For example, the length of each tape may depend on how pre-programmed configurations were selected to guide layup. The tape length may run from top to bottom in the images. However, alternative widths and orientations may be used without departing from the scope of the current disclosure.

Within the graphical user interface, an end-user may select a tape for viewing, prompting the grouping algorithm to create tape-level defects for a given tape. The defects that are generated are determined by filter settings applied by the user. For example, the user may request a mask to be generated for a given defect type, which will prompt the grouping algorithm to evaluate every defect matching that type to ensure they are within the filter requirements. If the defect's height and width fall outside of specified parameters, they will not be drawn onto the mask image or converted into a tape-level defect. Otherwise, they are drawn onto the mask and the process continues.

Within the IAMIS GUI, defect filter configurations can be found in a sidebar labeled as “defect filters”. Each defect can be enabled or disabled, which when toggled will trigger a recalculation of the tape-level defects for that defect type, along with the GUI updating the image, defect information, and 3D viewport to reflect the change. Within the IAMIS GUI there are also minimum width and height sliders for gap and overlap defect types, as well as minimum height sliders for splices, missing tows, twisted tows, and wrinkled tows. These will similarly trigger a recalculation of tape-level defects for their respective defect types when changed.

In an embodiment, the IAMIS executes an augmented reality application such that the system is configured to allow the user to see the defects of a sample in an Augmented Reality environment. The program accomplishes this after performing three different setup procedures: Scanning QR codes, Spawning a tool model and Drawing the defects as lines. In an example, the HoloLens available from Microsoft Corporation is-would serve as a suitable augmented reality system for use with aspects of the present disclosure. However, alternative methods of visualization may be used without departing from the scope of the current disclosure.

In some examples, the first step in visualization is scanning a code. In an example, a QR code is scanned. The actual reading of the QR code is taken care of by the augmented reality system's internal software, the user needs only to look at a code closely, and it will read all of the information. Once scanned in the program, if the software is set to a default setting which configures it to listen for QR codes, the software generates a new QR code game object. Once created, the object gets assigned all the values of the QR code, such as the coded text, timestamp, and size. However, the code does not have to be assigned any information, as it may also serve the purpose of being a “home location indicator”. In other words, the generated object is moved to match the location of the physical code so that they overlap, which keeps reported locations consistent. With the QR code loaded, the software may proceed with generating the rest of the required game objects.

It should be noted that it is within the scope of the present disclosure to use an identification code other than a QR code to generate game objects and retrieve information. For example, barcodes, data matrices, and RFID tags are all suitable options for use as an identification code. It should be clear that these examples are provided and are non-limiting, as other types of codes are within the scope of the current disclosure.

In an embodiment, in order to spawn the tool, a stereolithography file (e.g., stl design format) of the tool is added to the application's persistent data storage. A new prefab (prefabricated asset) game object for the model is then created. This prefab contains a transform component that controls its position and a Mesh Renderer that will hold the model. Then the model is added to the renderer. The transform of the object is matched with the transform of the identification code that was scanned, which makes it so that the model is at the same position and angle as the scanned QR code.

Drawing defect lines begins with a .txt file containing all of the defect information. This .txt file is located in the application's persistent data storage. Defect type and defect contour data points are retrieved from the file. Using this data, a new SplitLine object was created. For each SplitLine, a new game object prefab is created this time containing a Line Renderer component. Next, the data points are assigned to the line renderer from SplitLine, which is configured to draw the line in the 3D space. Subsequently, the defect type is addressed, and the line color is configured based on that Line prefab has a child object containing a Box Collider, which detects when the user touches the lines. The augmented reality system has its code folding with touch interactions, which enables said AR system to add a touchable component to the line object that it will trigger when the user touches it. The function that triggers when it touches the lines spawns a text box, which displays the Defect Data retrieved from the text file. The final stage is to transform the parent game object to the position and rotation of the identification code so that the defects are aligned with where the identification code is and, more importantly, where the tool is displayed.

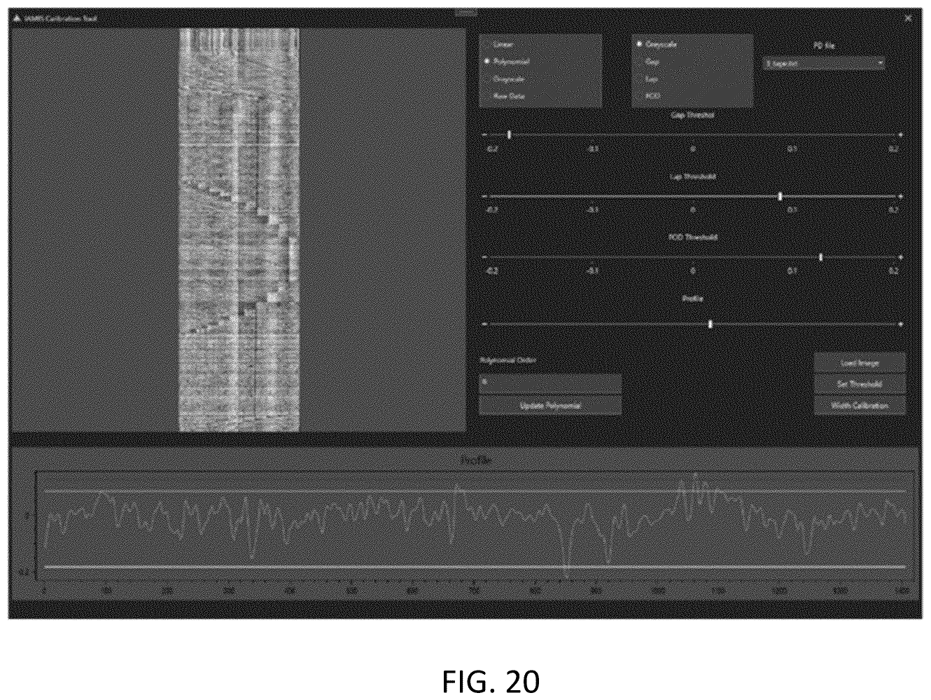

Those skilled in the art are aware that calibration is one of the most important steps in any inspection system. In order to increase the accuracy of IAMIS, a calibration tool was created to aid the user in optimizing all detection settings. The calibration tool has two windows: a depth calibration window and a width calibration window. The depth calibration tool has three main regions, as shown in FIG. 20. The first region is the image display; this indicates an image generated using the currently selected settings. The second region of the depth calibration window is the settings field. This section allows the user to change every key value relating to IAMIS detects. This region also provides for changing the run being analyzed rapidly. The final region of the depth calibration window is the profile chart. In several embodiments, this chart is a line graph which displays the user-selected profile from the above image. The selected profile is then shown in yellow on the image display. This graph also indicates the defect height thresholds over the current profile.

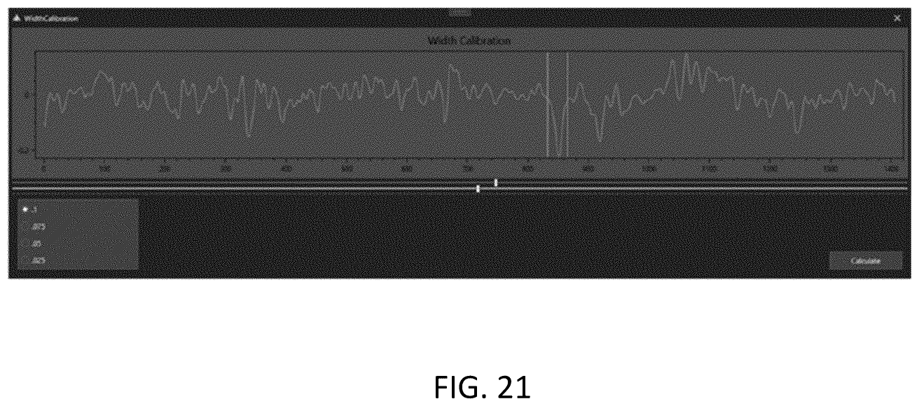

In some examples, the width calibration window appears more straightforward. An example of the width calibration window is shown in FIG. 21, which consists of a single graph with two sliders and a button. In an embodiment, the button includes the word “calculate”. The width calibration window may further comprise a list of known measurements. In an example, these measurements are listed in the bottom left corner as shown in FIG. 21. The graph displays the profile selected from the depth calibration screen and two vertical blue lines. When the two edges of a gap of know size are lined up with the two blue lines, the user selects the known width from the options in the bottom left corner and selects “calculate”.

Aspects of the present disclosure include a digital manufacturing twin (DMT) in-process inspection system calibration method using standardized workpieces, namely hard and/or living references. In an embodiment, the DMT in-process inspection system comprises laser profilometers as described above mounted onto AFP equipment such that it can scan the composite tows of material as they are deposited from the AFP system 10 onto the part. By combining frequent profile measurements made by the profilometers with positional feedback from the AFP system 10, a map of the location of deposited tows and defects in their fabrication may be created. To ensure the accuracy of the measurements made by the DMT system so that its inspection can be trusted in lieu of visual inspection, the system will need to be calibrated to accurately record location and size of defects and tow placement. To make this calibration effective for multiple types of composite tow and on various pieces of AFP equipment aspects of the present disclosure provide a robust calibration system that is material and equipment agnostic.

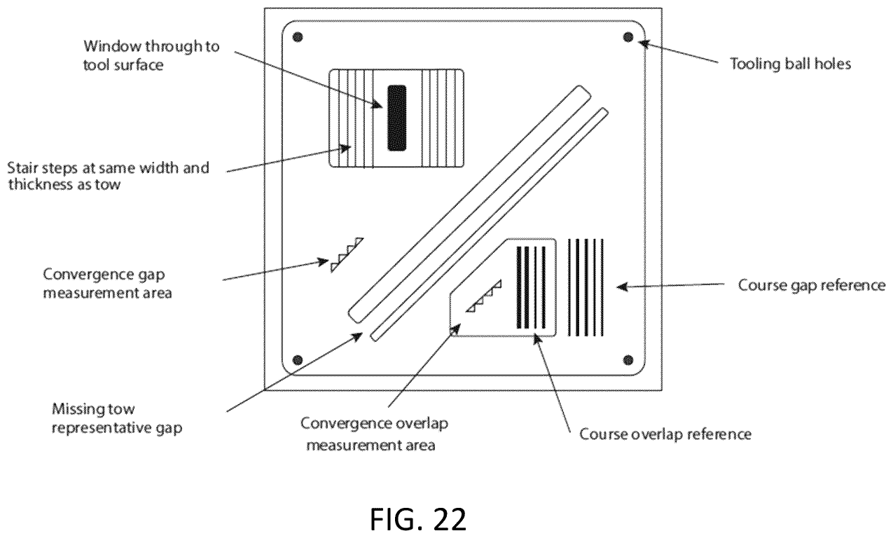

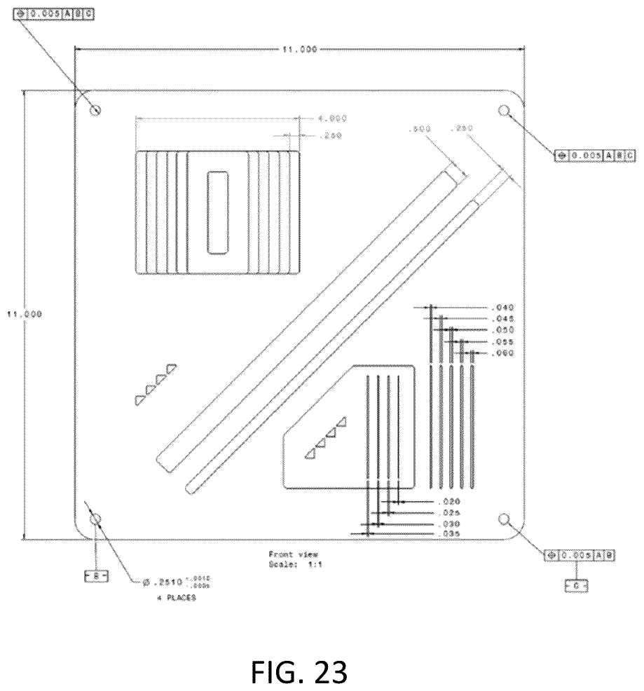

An example standardized workpiece is shown in FIG. 22, which depicts hard monument. Said standardized workpiece is a durable device that has representative features milled into it, and has been coated to approximate reflectivity of the composite. It has been accurately inspected so as to have a known reference size for all of its features. In an embodiment, the hard monument is manufactured from aluminum. However, it should be noted that manufacturing the hard monument from another durable material other than aluminum is to be considered within the scope of the current disclosure. FIG. 23 illustrates example sizes of the representative features. It should be clear that the representative features may include, but are not limited to, gaps, overlaps, convergence gaps, convergence overlaps, and missing tows.

A living monument shown is an AFP layup made of the same composite material as will be used in making the parts the DMT system will be inspecting. The living monument is programmed to have a number of defects such as gaps and overlaps in a variety of sizes for use in calibration. The size of those defects will be inspected, before being used for calibration, with outside equipment such as but not limited to a Leica T-Scan surface scanner, or a digital microscope. Other methods of inspection of the living monument may be used without departing from the scope of the present disclosure. The calibration defects are multiple sizes of gap and overlap between courses. Defects other than gaps and overlaps may also be included on the living monument without departing from the scope of the present disclosure.

A method of calibration is also disclosed herein, which includes starting from an inspected hard monument measure the plate with the DMT system, and adjusting the DMT system to get accurate measurements of the representative features and tow lane locations. This step will hereinafter be referred to as “Step A”.

The next step of the method of calibration, or step B, includes moving to the inspected living monument the DMT system can have its gain and position/angle adjusted to compensate for unique reflectivity of the composite tows until it is accurately measuring overlaps and gaps in the living monument. After the system has been adjusted for composite reflectivity, the method further comprises returning to the hard monument and repeating Step A. This repetition is Step C. Finally, the method includes repeating steps A through C until the system accurately measures the features of the hard and living monuments with no adjustment required between monuments. After successfully completing each of the above steps, the system is now ready for further testing on more complicated intentional defect layups for doing probability of detection studies and use on actual part layups.

To enhance the manufacturing experience during AFP layup, a manufacturing AI model and algorithm may be used. In some examples, the AFP system 10 is pre-programmed with instructions for processing the composite material tows. Those processing parameters may include information such as heating instructions, compaction and roller pressure, and AFP head speed. During layup, IAMIS may read manufacturing information, such as heat, compaction, and speed, and run it through the AI model in order to perform one or more operations that facilitate decreasing the likelihood of a defect occurring. IAMIS is configured to read each of the machine parameters in-process, and produce a notification to the user about any potential defects that could occur. The AI model may provide real-time feedback to change at least one processing parameter correlated to the defects detected by IAMIS. Utilizing this AI and machine learning model, operators gain real-time feedback and indications about the part being laid up, as well as the necessary changes needed to fix any potential defects and improve overall part quality.

Moreover, AFP manufacturing applications, such as those within the aerospace industry, have stringent certification requirements. Every ply must be certified by a trained inspector to be free of unacceptable defects. The conventional process for certification requires the trained inspector to personally conduct a visual inspection of each ply to determine whether there are any defects outside a predetermined scope of what is acceptable. The trained inspector is responsible for visually identifying any gaps, overlaps, twisted tows, or foreign object debris visible to the naked eye, then determine whether the defect is acceptable or unacceptable by reference to established defect tolerances. This manual inspection and certification process is disruptive and adds considerable cost and time to every AFP manufactured part. Further, there are a number of defects that are not easily detected with the naked eye that may be missed by manual inspectors. The in-process inspection system as described herein is configured to flag defects in-situ, so that the trained inspector can make a visual inspection of each ply more quickly than the conventional process. Further, the in-process inspection system of the present disclosure enables substantial automation of AFP certification, leading to substantial new efficiencies in AFP manufacturing.

The in-process inspection system described herein may be used for automated fiber placement (AFP) manufacturing. For example, the in-process inspection system may be integrated with an AFP machine configured to deposit composite material tows onto an AFP workpiece. The in-process inspection system includes at least one profilometer coupled to an AFP head of the AFP machine, and an automated inspection module. The profilometer is configured to collect profile data associated with the AFP workpiece by scanning the composite material tows during operation of the AFP machine. The automated inspection module comprises a computer having one or more processors and a non-transitory computer readable storage medium. The computer is communicatively coupled to the AFP machine and to the profilometer. The computer is configured to convert the profile data into a grayscale image of the AFP workpiece, identify a plurality of characteristics in the grayscale image indicative of one or more defects in the AFP workpiece, and detect the one or more defects in the AFP workpiece based on the identified characteristics during operation of the AFP machine. In some examples, the computer is configured to detect a missing tow, a foreign object debris, a twisted tow, a folded tow, a wrinkled tow, a marked splice, an unmarked splice, a backer tape defect, an overlap defect, and/or a gap defect. The computer may include a manufacturing artificial intelligence (AI) model stored in the non-transitory computer readable storage medium. The manufacturing AI model may be configured to receive the one or more detected defects during operation of the AFP machine, correlate the one or more detected defects with at least one processing parameter; and provide real-time feedback to change the at least one processing parameter. The computer may be configured to present a location of the one or more defects on the AFP workpiece, a type of the one or more defects on the AFP workpiece, and/or an identification of a cumulative defect. The computer may be configured to present the characteristics using a defect grid, an image overlay, and/or a 3D viewport. The computer may be configured to process the profile data to create a batch image of the AFP workpiece. The computer may be configured to process the batch image to include a region of interest on the batch image.

The method of in-process inspection described herein includes acquiring a grayscale image of an automated fiber placement (AFP) workpiece, executing a series of detection algorithms on the grayscale image to identify a plurality of characteristics in the grayscale image indicative of one or more defects in the AFP workpiece, and detecting the one or more defects in the AFP workpiece based on the identified plurality of characteristics. The series of detection algorithms may be executed on the grayscale image to detect a missing tow, a foreign object debris, a twisted tow, a folded tow, a wrinkled tow, a marked splice, an unmarked splice, and/or a backer tape defect. The series of detection algorithms may include and/or use a thresholding algorithm and/or a morphology algorithm to detect a gap defect and/or an overlap defect. The series of detection algorithms may include and/or use a height machine learning model trained to detect a splice, a missing tow, a twisted tow, a wrinkled tow, and a folded tow. The series of detection algorithms may include and/or use a luminance model trained to detect a marked splice and a backer tape. A plurality of AFP robot positions may be acquired during a timeframe of AFP operation, wherein each AFP robot position of the plurality of AFP robot positions has a corresponding time stamp during the timeframe of AFP operation. A plurality of profiles may be captured with a profilometer during a timeframe of AFP operation, wherein each profile of the plurality of profiles has a corresponding time stamp during the timeframe of AFP operation. Each profile of the plurality of profiles may be correlated with a respective AFP robot position of the plurality of AFP robot positions based on the corresponding time stamp during the timeframe of AFP operation. The plurality of profiles may be grouped to create a batch image of the AFP workpiece. The batch image may be processed to include a region of interest on the batch image, wherein the series of detection algorithms are performed on the region of interest. A plurality of batch images of the AFP workpiece may be captured, and the plurality of characteristics in the grayscale image may be compiled across the plurality of batch images with a grouping algorithm into a main defect list. The plurality of characteristics in the grayscale image may be measured to determine whether at least one parameter of the one or more defects in the AFP workpiece is outside of a predetermined, acceptable tolerance range for a defect measurement within the AFP workpiece. A model grayscale image of a standardized workpiece may be acquired, wherein the standardized workpiece includes one or more physical features of known dimensions. The series of detection algorithms may be executed on the model grayscale image to identify a plurality of model characteristics in the model grayscale image indicative of one or more model defects in the standardized workpiece. At least one of a depth calibration window and a width calibration window may be generated. The depth calibration window and/or width calibration window may be used to compare the plurality of model characteristics in the model grayscale image to the known dimensions of the one or more physical features of the standardized workpiece. The series of detection algorithms may be calibrated based on the comparison.

Embodiments of the present disclosure may comprise a special purpose computer including a variety of computer hardware, as described in greater detail herein. For purposes of illustration, programs and other executable program components may be shown as discrete blocks. It is recognized, however, that such programs and components reside at various times in different storage components of a computing device, and are executed by at least one data processor of the device.

Although described in connection with an example computing system environment, embodiments of the aspects of the present disclosure are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one of combination of components illustrated in the example operating environment. Examples of computing systems, environments, and/or configurations that may be suitable for use with aspects of the present disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored as one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

It should be known that the order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additionally, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the disclosure. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A method of in-process inspection comprising:
acquiring a grayscale image of an automated fiber placement (AFP) workpiece;
executing a series of detection algorithms on the grayscale image to identify a plurality of characteristics in the grayscale image indicative of one or more defects in the AFP workpiece; and
detecting the one or more defects in the AFP workpiece based on the identified plurality of characteristics.

2. The method of claim 1, wherein executing the series of detection algorithms on the grayscale image comprises detecting at least one of a missing tow, a foreign object debris, a twisted tow, a folded tow, a wrinkled tow, a marked splice, an unmarked splice and a backer tape defect.

3. The method of claim 1, wherein executing the series of detection algorithms on the grayscale image comprises executing a plurality of thresholding and morphology algorithms to detect at least one of a gap defect and an overlap defect.

4. The method of claim 1, wherein executing the series of detection algorithms on the grayscale image comprises training a height machine learning model to detect a splice, a missing tow, a twisted tow, a wrinkled tow, and a folded tow.

5. The method of claim 1, wherein executing the series of detection algorithms on the grayscale image comprises training a luminance model to detect a marked splice and a backer tape.

6. The method of claim 1, further comprising acquiring a plurality of AFP robot positions during a timeframe of AFP operation, wherein each AFP robot position of the plurality of AFP robot positions has a corresponding time stamp during the timeframe of AFP operation.

7. The method of claim 1, wherein acquiring the grayscale image of the AFP workpiece comprises capturing a plurality of profiles with a profilometer during a timeframe of AFP operation, wherein each profile of the plurality of profiles has a corresponding time stamp during the timeframe of AFP operation.

8. The method of claim 7, further comprising correlating each profile of the plurality of profiles with a respective AFP robot position of the plurality of AFP robot positions based on the corresponding time stamp during the timeframe of AFP operation.

9. The method of claim 7, further comprising grouping the plurality of profiles to create a batch image of the AFP workpiece.

10. The method of claim 9, further comprising processing the batch image to include a region of interest on the batch image, wherein the series of detection algorithms are performed on the region of interest.

11. The method of claim 7, further comprising:
capturing a plurality of batch images of the AFP workpiece; and
compiling the plurality of characteristics in the grayscale image across the plurality of batch images with a grouping algorithm into a main defect list.

12. The method of claim 1, further comprising measuring the plurality of characteristics in the grayscale image to determine whether at least one parameter of the one or more defects in the AFP workpiece is outside of a predetermined, acceptable tolerance range for a defect measurement within the AFP workpiece.

13. The method of claim 1, further comprising:
acquiring a model grayscale image of a standardized workpiece, wherein the standardized workpiece includes one or more physical features of known dimensions;
executing the series of detection algorithms on the model grayscale image to identify a plurality of model characteristics in the model grayscale image indicative of one or more model defects in the standardized workpiece;
generating at least one of a depth calibration window and a width calibration window;
using the at least one of the depth calibration window and the width calibration window to compare the plurality of model characteristics in the model grayscale image to the known dimensions of the one or more physical features of the standardized workpiece; and
calibrating the series of detection algorithms based on the comparison.

14. An in-process inspection system for automated fiber placement (AFP) manufacturing, the in-process inspection system integrated with an AFP machine configured to deposit composite material tows onto an AFP workpiece, the in-process inspection system comprising:
at least one profilometer coupled to an AFP head of the AFP machine, the at least one profilometer configured to collect profile data associated with the AFP workpiece by scanning the composite material tows during operation of the AFP machine;
an automated inspection module comprising a computer having one or more processors and a non-transitory computer readable storage medium, the computer communicatively coupled to the AFP machine and to the at least one profilometer, said computer configured to:
convert the profile data into a grayscale image of the AFP workpiece;
identify a plurality of characteristics in the grayscale image indicative of one or more defects in the AFP workpiece; and
detect the one or more defects in the AFP workpiece based on the identified characteristics during operation of the AFP machine.

15. The system of claim 14, wherein said computer is further configured to detect at least one of a missing tow, a foreign object debris, a twisted tow, a folded tow, a wrinkled tow, a marked splice, an unmarked splice, a backer tape defect, an overlap defect, and a gap defect.

16. The system of claim 14, wherein said computer includes a manufacturing artificial intelligence (AI) model stored in the non-transitory computer readable storage medium, the manufacturing AI model configured to:
receive the one or more detected defects during operation of the AFP machine;
correlate the one or more detected defects with at least one processing parameter; and
provide real-time feedback to change the at least one processing parameter.

17. The system of claim 14, wherein said computer is further configured to present at least one of a location of the one or more defects on the AFP workpiece, a type of the one or more defects on the AFP workpiece, and an identification of a cumulative defect.

18. The system of claim 14, wherein said computer is further configured to present the plurality of characteristics using one or more of a defect grid, an image overlay, and a 3D viewport.

19. The system of claim 14, wherein said computer is further configured to process the profile data to create a batch image of the AFP workpiece.

20. The system of claim 19, wherein said computer is further configured to process the batch image to include a region of interest on the batch image.
